(19) United States
(12) Patent Application Publication
(10) Pub. No.: US 2026/0015261 A1
(43) Pub. Date: Jan. 15, 2026

(54) ENHANCING DESALINATION REACTION BY MODIFYING OXIDATION RATE

(71) Applicant: Badwater Alchemy Inc., Seattle, WA (US)

(72) Inventors: Ozgur Emek Yildirim, Bellevue, WA (US); Andrew F. Mason, Seattle, WA (US); William J. Walker, Seattle, WA (US)

(21) Appl. No.: 19/268,613

(22) Filed: Jul. 14, 2025

Related U.S. Application Data
(60) Provisional application No. 63/670,553, filed on Jul. 12, 2024.

(51) Int. Cl. C02F 1/28; C02F 1/00; C02F 103/08

(52) U.S. Cl. CPC C02F 1/281; C02F 1/004; C02F 1/008; C02F 2001/007; C02F 2103/08; C02F 2209/006; C02F 2209/04; C02F 2303/18; C02F 2305/08

(57) ABSTRACT

An example method includes generating a mixture of metal particles and an aqueous solution including one or more solutes, the metal particles being configured to capture the one or more solutes by undergoing an oxidation reaction. The example method also includes detecting a condition of the mixture and comparing the condition of the mixture to a threshold. Based on comparing the condition of the mixture to the threshold, the example method includes increasing a rate that the metal particles capture the one or more solutes in the mixture by increasing or decreasing an ORP of the mixture.

### CROSS-REFERENCE TO RELATED APPLICATION

This application claims priority to U.S. Provisional App. No. 63/670,553, which was filed on Jul. 12, 2024, is titled “ENHANCING DESALINATION REACTION BY MODIFYING OXIDATION RATE,” and is incorporated by reference herein in its entirety.

### BACKGROUND

Freshwater is essential for agricultural, industrial, and domestic uses. According to the United Nations (UN), about half of the world's population experiences severe freshwater scarcity every year (UN World Water Development Report, 19 Mar. 2024). An increase in freshwater demand from trends of population growth and socio-economic development may further exacerbate this problem.

Freshwater can be produced by desalinating brackish water and seawater, which is more readily available than existing freshwater. Desalination is increasingly important for producing drinking water and irrigation water in arid climates. For example, a majority of drinking water in Israel is now produced using desalination. In the United States (US), desalination plants in some areas already produce a significant amount of municipal drinking water. Many existing desalination plants utilize reverse osmosis (RO) for water desalination. However, RO and many other previous desalination technologies (e.g., distillation, ion exchange, electrodialysis, etc.) have several drawbacks that prevent widespread use. For instance, many of these techniques utilize significant energy expenditures during operation. Other costs, as well as reliability concerns, associated with these techniques limit their widespread use.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example desalination system in accordance with various implementations of the present disclosure.

FIG. 2 illustrates an example environment for controlling a desalination system, such as the desalination system described above with reference to FIG. 1.

FIGS. 3A and 3B illustrate examples of iron nanoparticles configured to adsorb sodium (Na) and chlorine (Cl) atoms.

FIG. 4 illustrates at least one example device configured to enable and/or perform various functionality discussed herein.

FIG. 5 illustrates an example process for removing solutes from water.

FIG. 6 illustrates observed desalination as a function of Oxidation-Reduction Potential (ORP).

FIG. 7 illustrates an example process for capturing solutes from an aqueous solution.

### DETAILED DESCRIPTION

Various systems, devices, and methods described herein relate to improved techniques for removing solutes from water, such as sodium ions, chloride ions, magnesium ions, and other dissolved salts. According to various examples, techniques described herein can remove solutes from water with minimal energy expenditures and costs.

In various cases, a mixture is generated by introducing a liquid desalination media containing metal particles to an aqueous solution of solutes. In particular cases, the particles include iron (e.g., zero-valent iron (ZVI)). In some examples, the particles include at least one of copper, aluminum, or zinc. In some examples, metal atoms within the particles are configured to oxidize, such as in the presence of water and an oxidizing gas (e.g., air) that is injected into the mixture. For instance, one or more species of metal oxyhydroxides are generated in the particles. In various cases, electrostatic forces of atoms within the particles attracts the solutes to the particles, thereby capturing the solutes from the mixture. When the particles (with the attached solutes) are removed from the mixture, the resultant water has a significantly lower concentration of the solutes than the original aqueous solution prior to treatment. In some cases, the water is further treated using an RO device. Seawater, saline, brine, and other types of aqueous solutions can be treated using various implementations described herein, in order to yield treated water that may be suitable for irrigation uses and/or for human consumption.

In various implementations, techniques for controlling the rate of oxidation and/or the dominant oxidation state of the metal atoms within the particles are also described. For example, certain oxidation states in the iron of ZVI nanoparticles during desalination can enhance the efficiency and/or rate of the desalination reaction. Other conditions may also impact the desalination reaction, such as a temperature of the water, an Oxidation-Reduction Potential (ORP) of the water, a pH of the water, a concentration of the dissolved salt in the water, an amount of the metal, or a valency state of the metal. It may be beneficial, in some cases, to increase or decrease the rate of oxidation within a desalination reactor (e.g., a desalination tank) in order to enhance the desalination reaction.

In various implementations of the present disclosure, techniques can be utilized to remove at least 75% of an amount of one or more solutes (e.g., salt) from the aqueous solution. In some cases, at least 80% of the solute(s) can be removed from the aqueous solution. The efficiency of the process can be impacted by the amount of solute(s) in the original aqueous solution, the amount of particles in the desalination media, the amount of metal in the desalination media relative to the volume of the aqueous solution, the amount of time the particles are present in a mixture with the aqueous solution prior to particle removal, the amount of oxidizing gas introduced into the mixture, the pH of the mixture, features of a desalination system that facilitates the desalination process, and other characteristics of implementations of the process described herein.

Various implementations of the present disclosure will now be described with reference to the accompanying figures.

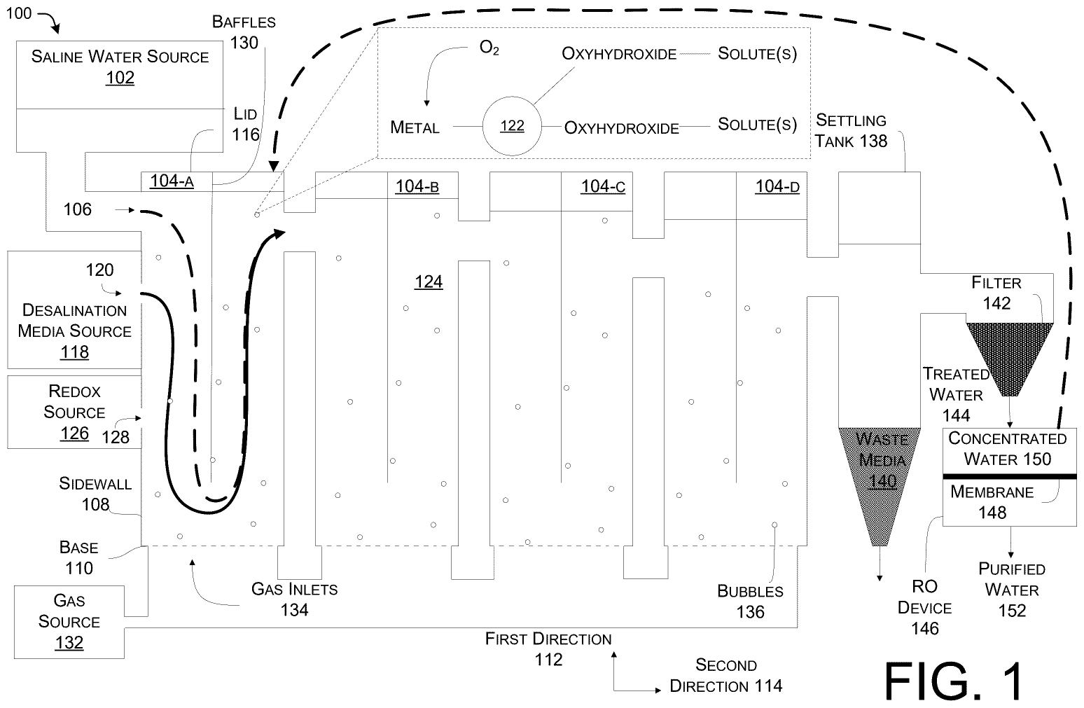

FIG. 1 illustrates an example desalination system 100 in accordance with various implementations of the present disclosure. The desalination system 100 receives saline water from a saline water source 102. That is, the saline water may be influent water into the desalination system 100. As used herein, the terms “saline,” “saline water,” and their equivalents, may refer to an aqueous solution including dissolved salts, metals, solids, other contaminants, or any combination thereof at greater than a threshold concentration (e.g., greater than 3% salinity). In some cases, other types of aqueous solutions including other dissolved solutes can be substituted for the saline water in the saline water source 102. In various cases, saline water is unfit for human and/or animal consumption. In some cases, saline water is unfit for a water supply for plants, such as in an agricultural context. In various examples, saline may include seawater, industrial waste, mining waste, agricultural waste, produced water (e.g., a byproduct of ground oil and/or gas extraction), flowback (e.g., water injected and returned during a hydraulic fracturing process), or any combination thereof. In some examples, saline water includes brine. As used herein, the term “brine,” and its equivalents, may refer to an aqueous solution having greater than 5% salinity. The saline water source 102, for instance, includes a tank. The term “tank” and its equivalents refer to a vessel, container, or the like configured to hold a liquid, a solid, a slurry, a mixture, a gas, or any combination thereof. In implementation, a tank can be fluidically connected to other tanks, pipes, pumps, valves, or other structures. In some cases, the saline water source 102 includes one or more pipes, pumps, tanks, valves, or other structures by which saline water can be transported to the desalination system 100. In some cases, the saline water has a nonzero total dissolved solid (TDS), such as a TDS in a range of about 10,000 parts-per-million (ppm) to about 100,000 ppm.

The saline water enters a first desalination tank 104-a through a water inlet 106, which is fluidly coupled to the saline water source 102. In the example illustrated in FIG. 1, the water inlet 106 extends through a sidewall 108 of the first desalination tank 104-a. The sidewall 108 extends from a base 110 of the first desalination tank 104-a. The sidewall 108 may be parallel to a first direction 112 and the base 110 may be parallel to a second direction 114, wherein the first direction crosses the second direction. During operation of the desalination system 100, the first direction 112 may be opposite of a direction of gravity. In some cases, the sidewall 108 is perpendicular to the base 110. In some examples, the base 110 has a polygonal (e.g., rectangular) and/or circular shape. A lid 116 may be removably coupled to the sidewall 108. The sidewall 108, base 110, and lid 116 include one or more materials configured to contain water, such as saline water. In some examples, the sidewall 108 and base 110 include a metal (e.g., stainless steel), a polymer (e.g., polyethylene), glass, or any combination thereof.

In various implementations, a desalination media source 118 outputs a desalination media into the first desalination tank 104-a via a media inlet 120. In the example illustrated in FIG. 1, the media inlet 120 extends through the sidewall 108 of the first desalination tank 104-a. However, in some cases, the media inlet 120 extends through the lid 116 of the first desalination tank 104-a. The desalination media is configured to capture one or more solutes in the saline water output from the saline water source 102.

The desalination media, in various cases, includes a fluid (e.g., a slurry) containing particles 122. For example, the particles 122 include copper, aluminum, magnesium, manganese, zinc, iron, or any combination thereof. In some cases the particles 122 include an alloy of multiple metals. In some examples, the particles 122 include at least one oxidized metal. For instance, the particles 122 include one or more metal oxyhydroxides (e.g., iron oxyhydroxide). In some cases, the particles 122 may include a network structure of atoms (e.g., metal atoms and/or any combination of metal atoms, hydrogen atoms, and oxygen atoms) that are bonded to each other. The network structure may be cubic, tetragonal, or the like. The desalination media, for instance, includes a mixture of water and the particles 122. According to various cases, a concentration of the particles in the desalination media is in a range of 0.1 grams per liter (g/L) to 100 g/L, such as in a range of 1 g/L to 50 g/L or a range of 10 g/L to 25 g/L.

According to various cases, the particles 122 include one or more metals in a zero valency state, such as zero-valent iron (ZVI). As used herein, the term “Zero Valent Iron (ZVI),” “zerovalent iron,” “nonvalent iron,” “Fe(0),” and their equivalents, can refer to one or more iron atoms with a valency of zero. In some cases, iron can change between a zerovalent state and a multivalent state, such as the trivalent Fe3+ form.

When metal atoms on the surface of the particles 122 become oxidized, the atoms may be converted into multivalent metal atoms. As used herein, the term “oxidation,” and its equivalents, can refer to a chemical reaction in which at least one atom loses electrons. As used herein, the term “reduction,” and its equivalents, can refer to a chemical reaction in which at least one atom gains electrons. In a “reduction-oxidation” or “redox” reaction, electrons are transferred from one chemical species (e.g., a species undergoing oxidation) to another chemical species (e.g., a species undergoing reduction). For example, ZVI can be oxidized when it reacts with an oxidizing species (e.g., oxygen gas, air, ozone, etc.) to form other valency states, such as Fe(II) and/or Fe(III). In particular cases, the particles 122 include an oxyhydroxide, such as Fe(III) oxyhydroxide, (FeO(OH).

When one or more metals in the particles 122 are converted into a multivalent state, such as through the process of oxidation, the resultant material may include charged atoms. For instance, oxygen atoms in the oxyhydroxide(s) of the particles 122 may be negatively charged, whereas hydrogen atoms in the oxyhydroxide(s) of the particles 122 may be positively charged. In various cases, the electrical charges of various atoms within the particles 122 is dependent on the pH of the bulk solution. The positive and negative charges of various atoms within the particles 122 causes the particles 122 to electrostatically attract charged solutes in the vicinity of the particles 122. For instance, negatively charged solutes (e.g., chloride ions) in the saline water may be electrostatically attracted to positively charged atoms (e.g., hydrogen atoms) in the particles 122. Further, positively charged solutes (e.g., sodium ions) in the saline water may be electrostatically attracted to negatively charged atoms (e.g., oxygen atoms) in the particles 122. Further, in some instances, the charged solutes may become covalently bonded to each other and/or to metals on the surface of the particles. Accordingly, the charged solutes in the saline water may be adsorbed onto the surfaces of the particles 122. In various cases, the particles 122 are configured to remove dissolved salts, such as dissolved sodium chloride, from the saline water. Accordingly, the particles 122 may be utilized to at least partially desalinate the saline water.

In some cases, the desalination media includes additional materials. In various cases, the desalination media is generated as a mixture of metal salts and a reducing agent. Examples of the metal salts include, for instance, metal chlorides (e.g., iron chloride), metal nitrates (e.g., iron nitrate), metal sulfates (e.g., iron sulfate), or other types of metal salts. Examples of the reducing agent, in various cases, include uric acid, urea, tartaric acid, maleic acid, or tannic acid. According to various examples, the desalination media may be acidic. For instance, the desalination media may have a pH in a range of 2 to 7, such as a pH in a range of 2.5 to 5.0. In some implementations, the desalination media may be configured to be stored for an extended period of time (e.g., days, weeks, months, or years), and may include one or more materials configured to prevent or minimize bacterial growth within the desalination media during storage. In some cases, the desalination media is stored in a kit (e.g., including a polymer package that prevents contamination during storage).

In various examples, the particles 122 within the desalination media include nanoparticles. As used herein, the term “nanoparticle,” and its equivalents, can refer to a solid particle that is shorter than 100 nanometers (nm) in at least one dimension. In some cases, a nanoparticle can have a diameter of less than 100 nm. As used herein, a “size,” “length,” “diameter,” or their equivalents of a particle may refer to a Z-average diameter (e.g., as determined using Dynamic Light Scattering (DLS)). In some cases, a “size,” “length,” “diameter,” or their equivalents, of multiple particles may refer to a Z-average diameter in which the particles have a weighted differential size distribution within ±10% of the Z-average diameter. In various implementations described herein, the particles 122 may, for instance, may be assumed to have spherical shapes, such that a Z-average diameter of the particles 122 (e.g., generated using DLS) in suspension may be between 1 and 100 nm. In some cases, the nanoparticles among the particles 122 may have a Z-average diameter that is between 40 to 60 nm, such as about 50 nm. In some implementations, at least 90% of a (volume or intensity) weighted differential size distribution of the particles 122 in solution (e.g., generated using DLS) may be between 20 and 80 nm, such as about 50 nm. In some cases, the length of the particle 122 can be defined by microscope measurements (e.g., via at least one optical microscope, an electron microscope, a scanning probe microscope, or the like), settling velocities (e.g., by applying Stokes' law to a measured velocity of the particle), and/or sedimentation methods.

A mixture 124 of the saline water and the desalination media travel through a fluid circuit including an interior space of the first desalination tank 104-a. In various cases, the fluid circuit further includes the interior of a second desalination tank 104-b, a third desalination tank 104-c, and a fourth desalination tank 104-d. The first to fourth desalination tanks 104-a to 104-d are connected to one another in series, such that the mixture 124 travels through the first desalination tank 104-a, then the second desalination tank 104-b, then the third desalination tank 104-c, then the fourth desalination tank 104-d.

According to various implementations, the desalination media source 118 outputs an amount of desalination media into the fluid circuit (e.g., to form the mixture 124) that is dependent characteristics of the saline water output into the fluid circuit. For instance, a ratio of a mass of the particles 122 to a volume of the saline water is in a range of 0.01 g/L to 1.0 g/L, such as in a range of 0.04 g/L to 0.50 g/L. In some cases, the amount of the desalination media introduced into the fluid circuit is dependent on a salinity of the saline water. In various cases, the salinity of the saline water is represented in units of electrical conductance, such as millisiemens per centimeter (mS/cm) or mS per meter (mS/m). In some examples, the salinity of the saline water is measured by inserting electrodes into the saline water, applying a voltage between the electrodes, measuring a current between the electrodes, and calculating the electrical conductance based on the voltage and the current. In various implementations, a ratio of a mass of the particles 122 added to the fluid circuit to a salinity of the saline water in the mixture 124 is in a range of 0.1 g/(mS/cm) to 0.5 g/(mS/cm) or 0.1 g/(mS/m) to 0.5 g/(mS/m).

In various implementations, the particles 122 are configured to remove dissolved salt from the mixture 124 while dwelling within the fluid circuit. In various implementations, a retention time (also referred to as a “dwell time”) of the mixture 124 in the fluid circuit is in a range of five minutes to 1 hour. Experimentally, it has been determined that the efficacy of salt removal within the fluid circuit is dependent on the pH of the mixture 124. In various implementations, a buffer source (not shown) is configured to inject, through a buffer inlet (not shown), a buffer solution that adjusts the PH of the mixture 124. The buffer solution, in various cases, includes an aqueous solution that has a basic pH. For example, the buffer solution includes a hydroxide (e.g., calcium hydroxide and/or magnesium hydroxide) and/or a bicarbonate (e.g., calcium bicarbonate and/or magnesium bicarbonate). For instance, the buffer source may inject the buffer solution into the mixture 124 such that the mixture 124 has a pH in a range of 7.5 to 12.0.

In implementations, a redox agent source 126 is configured inject, through an inlet 128, a redox reaction altering material (also referred to as a “redox agent”) into the mixture 124. The redox reaction altering materials can increase or decrease a rate of the oxidation of the metal in the particles 122 within the mixture 124. A redox agent may be an oxidizing agent or a reducing agent, in various examples. In various implementations, the efficiency and rate of the capture of the dissolved salt within the water is dependent on the oxidation rate of the metal, therefore it may be beneficial to increase or decrease the rate of the oxidation reaction in order to enhance the desalination.

In implementations, increasing the rate of the oxidation can include, alone or in combination, adding an oxidizing agent to the water, increasing a temperature of the water, or increasing a retention time of the water in a fluid circuit enclosing the particles.

In implementations, the oxidizing agent can include at least one of oxygen, ozone, a peroxide, a hypochlorite, a perchlorate, a permanganate, nitric acid, or potassium dichromate. For example, the oxygen can include oxygen from air, the peroxide can include hydrogen peroxide, the hypochlorite can include sodium hypochlorite, the perchlorate can include sodium perchlorate, and the permanganate can include potassium permanganate. In implementations, the oxidizing agent can be introduced into the mixture 124 through the inlet 128 from the redox agent source 126. In various cases, the oxidizing agent is a gas and may be introduced from a gas source 132 and through gas inlets 134 within the base 110 of each desalination tank among the desalination tanks 104-a to 104-d. The gas, for instance, propagates through the mixture 124 in the form of bubbles 136. The bubbles 136 travel through the mixture 124 in the first direction 112. The gas in the bubbles 136, in various cases, includes an oxidizing gas that enhances the oxidation reaction of at least one the metal in the particles 122 (e.g., the formation of at least one oxyhydroxide). The gas, for example, includes at least one of air, oxygen, or ozone.

In implementations, increasing a temperature of the water may increase the rate of the oxidation of the metal in the particles. In some cases, increasing or decreasing a temperature of the water within desalination processes may have variable effects on oxidation of the metal and on removal of solutes from the water. For example, the effect of increasing or decreasing a temperature of the water may be dependent on the starting temperature of the water. In some cases, the temperature of the water may have a variable effect on oxidation and removal of solutes as the temperature approaches the boiling point of the water or the freezing point of the water. In implementations, the redox agent source 126 can include a heat exchanger configured to heat or cool the water in the mixture 124 based on a desired oxidation of the metal in the particles 122.

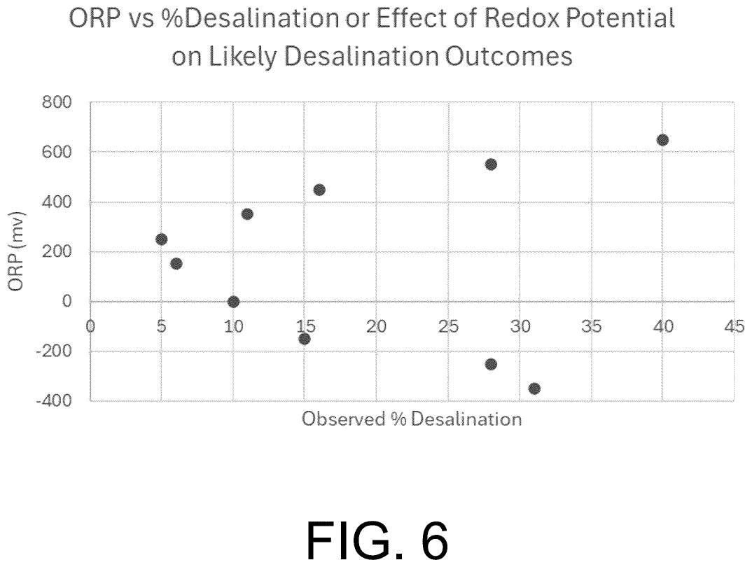

In implementations, decreasing the rate of the oxidation of the metal in the particles can include, either alone or in combination, reducing an amount of oxygen in the water, decreasing a temperature of the water, adding a reducing agent to the water, adding a sulfide and/or sulfate to the water, or decreasing a retention time of the water in a fluid circuit. In implementations, reducing an amount of oxygen in the water may change the Oxidation-Reduction Potential (ORP) of the water. As can be seen in FIG. 6, the ORP of water within processes of the present disclosure, such as the desalination system 100, shows a nonlinear effect on desalination. Therefore, reducing or increasing an amount of oxygen in the water may have an effect to both increase and decrease desalination of the water depending on multiple factors.

In implementations, reducing the amount of oxygen in the water can include, alone or in combination, adding nitrogen bubbles to the mixture 124, introducing oxygen consuming microorganisms to the water, or increasing a respiration rate of microorganisms in the water. In implementations, nitrogen gas (N₂) may be added to the mixture through the inlet 128 of the redox agent source 126. In implementations, the N₂ may be introduced from the gas source 132 and through gas inlets 134 within the base 110 of each desalination tank among the desalination tanks 104-a to 104-d. The gas, for instance, propagates through the mixture 124 in the form of bubbles 136. The bubbles 136 travel through the mixture 124 in the first direction 112. In implementations, adding N₂ bubbles to the water can be used to expel oxygen from water without participating in the oxidation reaction. In this way, N₂, an inert gas, can act as a reducing agent to reduce the amount of oxygen in the water. In some cases, adding N₂ bubbles to the water in effect creates anoxic conditions which can enhance desalination.

In implementations, introducing oxygen consuming microorganisms and/or increasing a respiration rate of oxygen consuming microorganisms can reduce the amount of oxygen in the water. For example, sulfate reducing bacteria can be used and can not only consume oxygen but can eliminate sulfate as well. Systems and methods of using microorganisms (bacteria) to consume oxygen and reduce sulfate are described in International Publication No. WO 2024227101 A2, which is incorporated by reference herein in its entirety. In implementations, oxygen consuming microorganisms can be added to the mixture 124 through inlet 128 from redox agent source 126. Increasing a respiration rate of oxygen consuming microorganisms can include adding a nutrient source, such as glucose or sucrose, to the water. In implementations, the nutrient source can be added to the mixture 124 through inlet 128 from redox agent source 126. In implementations, oxygen consuming microorganisms can be added to the saline water prior to entering the fluid circuit by the saline water source 102. In some cases, the amount of oxygen in the saline water can be reduced to a desired level by oxygen consuming microorganisms, and the oxygen consuming microorganisms can be removed from the saline water prior to entering the fluid circuit by the saline water source 102.

In implementations, the desalination system 100 can include additional steps to remove microorganisms from the water as needed. For example, the water can be passed through one or more filters, such as a sand filter, activated carbon, and a membrane filter. Membrane filters can include microfiltration, ultrafiltration, and reverse osmosis. Filter(s) to remove microorganisms from the mixture 124 can include filter 142 and RO device 146, or one or more additional filters can be used (not shown). The water can also be disinfected to kill the oxygen consuming microorganisms, for example, by adding chlorine, iodine, or ozone gas to the system, or by illuminating the system with ultraviolet (UV) light.

In implementations, decreasing a temperature of the water may decreasing the rate of the oxidation of the metal in the particles. In some cases, increasing or decreasing a temperature of the water within desalination processes may have variable effects on oxidation of the metal and on removal of solutes from the water. For example, the effect of increasing or decreasing a temperature of the water may be dependent on the starting temperature of the water. In some cases, the temperature of the water may have a variable effect on oxidation and removal of solutes as the temperature approaches the boiling point of the water or the freezing point of the water. In implementations, the redox agent source 126 can include a heat exchanger configured to heat or cool the water in the mixture 124 based on a desired oxidation of the metal in the particles 122.

In implementations, adding a reducing agent to the water can reduce amount of oxygen in the water. Examples of the reducing agent, in various cases, include nitrogen gas, an oxygen-consuming microorganism, a nitride, a nitrate, calcium, barium, sodium borohydride, an alcohol, a phenol, uric acid, urea, tartaric acid, maleic acid, or tannic acid. In implementations, the reducing agent can be added to the mixture 124 through the inlet 128 of the redox agent source 126. In various cases, if the reducing agent is a gas, the reducing agent can be introduced into the mixture 124 from the gas source 132 and through gas inlets 134.

In implementations, adding a sulfide and/or sulfate to the water can decrease the rate of oxidation of the metal. In some cases, both sulfide and sulfate can inhibit oxidation within the desalination system 100. Sulfide may consume the media by reacting with metal in the particles and therefore renders the metal unavailable for capturing dissolved salts within the water, reducing the rate of oxidation of the metal. The effect of sulfate effect is more dependent on the content of salt ions, such as Cl−, in the water. For example, if a Cl− to SO42− ratio is less than about 5, the reaction can be inhibited. In implementations, the sulfide and/or sulfate can be added to the mixture 124 through the inlet 128 of the redox agent source 126. In implementations, reducing an amount of sulfide and/or sulfate in the mixture 124 may be desired. Systems and methods of using microorganisms (bacteria) to reduce sulfate are described in International Publication No. WO 2024227101 A2, which is incorporated by reference herein in its entirety.

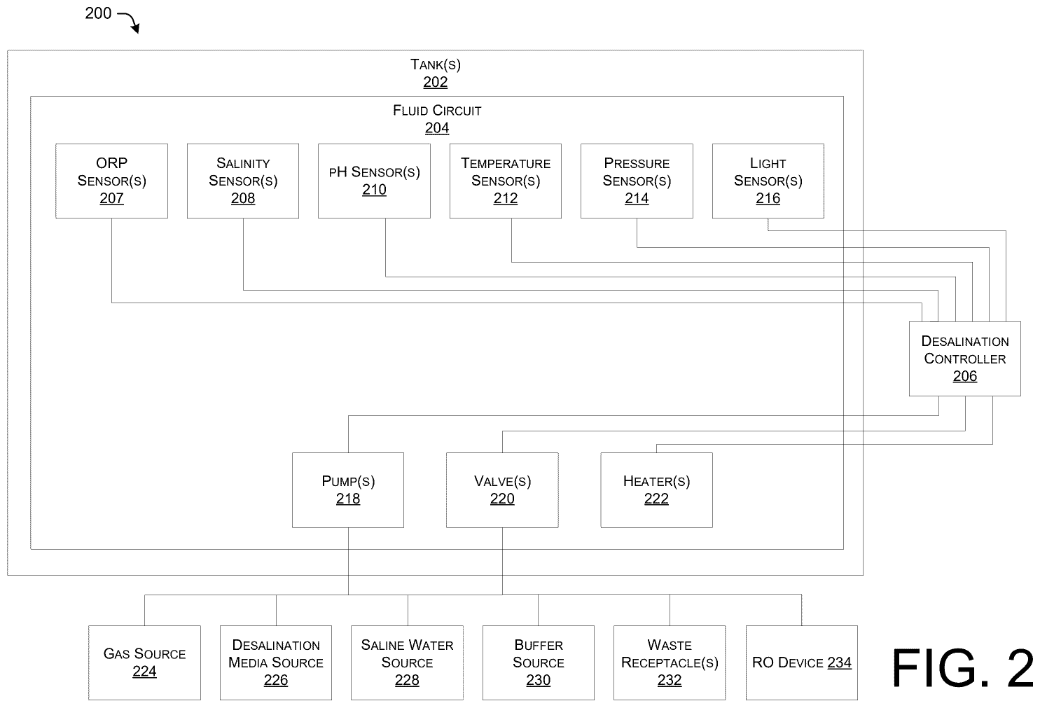

In implementations, the rate of oxidation is increased or decreased based on detecting a condition of the water or of the particles 122 within the mixture 124. For example, the condition can include at least one of a temperature of the water, an ORP of the water, a pH of the water, a concentration of the dissolved salt in the water, an amount of the metal, and a valency state of the metal. In implementations, the condition of the water and/or the particles 122 can be detected multiple times to provide information about the condition over time, such as a rate of change of the condition which can indicate an efficiency of the desalination system 100. In implementations, the conditions can be detected with sensors as described in FIG. 2, for example with one or more temperature sensors, ORP sensors, pH sensors, or salinity sensors. In implementations, an amount of the metal (concentration (mg/L), mass (mg), etc.) and/or a valency state of the metal can be measured by withdrawing a sample of the mixture 124 from the fluid circuit and measuring using conventional methods. In implementations, one or more parameters such as ORP, pH, electrical conductivity, and temperature can be correlated to an amount of the metal and/or a valency state of the metal, thereby allowing the amount and/or a valency state of the metal to be measured continuously.

In some cases, the addition of redox reaction altering materials from the redox agent source 126 and/or the gas source 132 can be mediated by a controller, such as the desalination controller 206.

The first to fourth desalination tanks 104-a to 104-d each include baffles 130. The baffles 130 extend parallel to the first direction 112 within the interior of each of the first to fourth desalination tanks 104-a to 104-d. In various implementations, the baffles 130 extend from the lid 116 of the corresponding desalination tank among the first to fourth desalination tanks 104-a to 104-d and are spaced apart from the base 110 of the corresponding desalination tank. In some cases, the baffles 130 may be coupled to a floatation device that floats on the surface of the mixture 124 and extends in a direction opposite to the first direction 112 into the mixture 124. In some cases, at least some of the baffles 130 are configured to extend from the base 110 of the corresponding desalination tank among the first to fourth desalination tanks 104-a to 104-d and are spaced apart from the lid 116 and/or an upper surface of the mixture 124. Due to the spacings between the baffles 130 and the walls of the desalination tanks 104-a to 104-d, the fluid circuit within the interior of the desalination tanks 104-a to 104-d may have a winding path through the desalination system 100. In some cases, the baffles 130 enhance turbulence and/or mixing within the mixture 124 when the mixture 124 is moving through the fluid circuit.

According to various implementations, the particles 122 within the mixture 124 are configured to capture one or more solutes within the mixture 124. In various implementations, at least one metal (e.g., iron, such as ZVI) in the particles 122 oxidizes within the mixture 124. In some cases, one or more metal oxyhydroxides are formed. As a result of the oxidation reaction, the solute(s) are bound to the particles 122. In various implementations, the solute(s) include one or more metals, such as at least one of copper, zinc, magnesium, manganese, aluminum, selenium, or one or more radionuclides. In some cases, the solute(s) include dissolved ions, such as at least one of magnesium, sodium, chloride, phosphate, sulfate, arsenic, nitrate, nitrite, or hypochlorite. In various implementations of the present disclosure, the particles 122 within the mixture 124 can be used to desalinate the mixture 124 by binding to sodium and/or chloride ions.

In particular cases, the solute(s) in their aqueous form are charged. For example, at least some of the solute(s) may have a positive charge. Examples of solutes having a positive charge include, for instance, sodium ions (Na+), copper ions (Cu2+), zinc ions (Zn2+), magnesium ions (Mg2+), manganese ions (Mn2+), aluminum ions (Al3+), or arsenic ions (As5+). The metal oxide in the particles 122 has a negative charge. Accordingly, the positively charged solute(s) may electrostatically bind to the oxidized particles 122. Further, at least some of the solute(s) may have a negative charge. Examples of solutes having a negative charge include, for instance, chloride ions (Cl−), selenium ions (Sn2−), phosphate ions (PO43−), sulfate ions (SO42−), nitrate ions (NO3−), nitrite ions (NO−), or hypochlorite ions (ClO−). The negatively charged solute(s) may electrostatically bind to the positively charged solute(s) bound to the particles 122. Various other mechanisms for capturing solute(s) are also possible.

In various cases, one than one gas can be introduced into the mixture 124 from a gas source 132 and through gas inlets 134 within the base 110 of each desalination tank among the desalination tanks 104-a to 104-d. The gas(s), for instance, propagate through the mixture 124 in the form of bubbles 136. The bubbles 136 travel through the mixture 124 in the first direction 112.

The gas in the bubbles 136, in various cases, can include at least one of an oxidizing gas a reducing gas, or additional gases to improve efficiency and/or safety of the desalination system 100, such as to disinfect or to prevent explosions, fires, and other risks when the desalination system 100 is operating. For instance, the gas may include nitrogen gas. In some examples, the gas includes air and/or ozone gas.

In at least a portion of the fluid circuit throughout the desalination system 100, the bubbles 136 move countercurrent to the desalination media within the mixture 124. For example, the particles 122 may travel in a direction that crosses and/or is opposite to the first direction 112 in at least a portion of the fluid circuit, while the bubbles 136 rise in the mixture 124 in the first direction 112. The baffles 130, in some cases, may cause the particles 122 and the mixture 124 to flow in a direction that opposes the first direction 112. In some examples, pumps and/or pipes (not illustrated) are included within the interior of the first to fourth desalination tanks 104-a to 104-d to cause the particles 122 from the desalination media to move countercurrent to the bubbles 136. In some cases, the bubbles 136 enhance mixing within the mixture 124.

To minimize space within the fluid circuit in which the bubbles 136 are not present, in various cases, the gas inlets 134 are distributed throughout the major area of the base 110. In some cases, the gas inlets 134 are distributed at a substantially even density throughout the base 110. For example, a number of gas inlets 134 per square area at a center of the base 110 may be substantially equal to a number of gas inlets 134 per square area at an edge of the base 110. The distribution of gas inlets 134 may prevent spaces within the desalination tanks 104-a to 104-d in which the bubbles 136 do not traverse, thereby increasing the volume within the fluid circuit in which the oxidizing reaction of the particles 122 takes place.

The size of the gas inlets 134 and/or the bubbles 136 may impact the efficiency of the reaction within the desalination system 100. In some cases, an individual gas inlet among the gas inlets 134 (e.g., each gas inlet 134) has a width in a range of 0.001 meter (m) to 0.1 m, a range of 0.001 m to 0.01 m, or the like. In some cases, the number of gas inlets 134 within a single base 110 is in a range of 1 to 1,000,000, 10 to 1,000, or 10 to 100.

Experimentally, it was observed that the rate of the gas entering the desalination tanks 104-a to 104-d can impact the efficiency of the desalination reaction. If the gas is introduced into the desalination tanks 104-a to 104-d at too low of a rate, the reaction may not be significantly enhanced by the gas. However, if the gas is introduced into the desalination tanks 104-a to 104-d at too fast of a rate, then the reaction may occur so quickly that the solute(s) may be inefficiently bound to the particles 122. Accordingly, in various implementations of the present disclosure, the gas is introduced into the mixture 124 (e.g., at an atmospheric pressure) at a rate in a range defined between a lower threshold and an upper threshold, such as in a range of 1.0 L/minute (min) to 100.0 L/min, such as a range of 1.0 L/min to 80.0 L/min or a range of 2.0 L/min to 80.0 L/min.

Once the mixture 124 traverses the final desalination tank in the fluid circuit (e.g., the fourth desalination tank 104-d), the mixture 124 flows into a settling tank 138. In some cases, the settling tank 138 lacks baffles 130. In various examples, the settling tank 138 substantially lacks bubbles 136. In some examples, the settling tank 138 is at least partially cone-shaped. When the mixture 124 is in the settling tank 138, the solute-laden particles 122 (which may have a greater size, width, volume, mass, etc. than unbound particles 122) spontaneously sink to the bottom of the interior of the settling tank 138 in the form of waste media 140. According to some cases, the solute-laden particles 122 in the waste media 140 form complexes of crystalized solutes (e.g., halite). In various cases, the waste media 140 is removed from the fluid circuit. In some cases, a valve at the base of the settling tank 138 selectively opens, thereby allowing the waste media 140 to drain from the settling tank 138. In some examples, a vacuum line is coupled to the base of the settling tank 138, which pulls the waste media 140 out of the settling tank 138. Once removed, the waste media 140 may be disposed of and/or recycled. For instance, solute(s) within the waste media 140 can be dried and stored and/or disposed of in a dried form. In some cases, particles 122 within the waste media 140 are introduced to a reducing agent, and the particles 122 are reused for solute removal (e.g., the recycled particles 122 are moved back into the desalination media source 118).

The remaining mixture 124 in the settling tank 138 flows into a filter 142. The filter 142, in various cases, further removes waste media 140 from the mixture 124. The waste media 140, in various cases, includes the solute(s) bound to the particles 122 from the mixture 124. According to some cases, the waste media 140 includes at least a portion of the TDS in the aqueous solution. In some examples, the solute(s) bound to the particles 122 have a larger size (e.g., width) than unbound particles 122, and can be therefore excluded from unbound particles 122 on the basis of size. In various cases, the filter 142 is a physical filter that includes activated carbon. For instance, the filter 142 includes a housing (e.g., a polymer and/or metal housing) that encloses activated carbon particles. In various cases, a remaining portion of the particles 122 bound to the solute(s) is removed from the mixture by the filter 142. The filter 142, in various cases, releases treated water 144.

In various implementations, the treated water 144 has significantly less dissolved salt than the saline water introduced into the fluid circuit by the saline water source 102. For instance, the treated water 144 omits at least 75% of the salt originally included in the saline water. In some cases, the treated water 144 omits at least 80%, 85%, or 90% of the salt originally included in the saline water. In various implementations, a salinity of (e.g., dissolved sodium ions and chloride ions) the treated water 144 is less than 25% (or less than 20%) of the salinity of the saline water originally received in the desalination system 100.

In some cases, however, at least a portion of the dissolved salt from the saline water is retained in the treated water 144. This portion of the dissolved salt may prevent the treated water 144 from being suitable for drinking water and/or agricultural uses. In various cases, the treated water 144 may have a salinity that is greater than or equal to 5.0 mS/cm, 4.0 mS/cm, 3.0 mS/cm, 2.0 mS/cm, 1.0 mS/cm, 0.7 mS/cm, 0.5 mS/cm, 0.1 mS/cm, or 0.0 mS/cm.

In various cases, a reverse osmosis (RO) device 146 is configured to substantially remove the remaining portion of the dissolved salt from the treated water 144. In various cases, the RO device 146 includes a membrane 148 that divides a first space and a second space. The membrane 148 is semipermeable, such that water can pass through the membrane 148 but ions (e.g., sodium and/or chloride ions) and particles cannot move through the membrane 148. In some cases, the membrane 148 includes cellulose acetate, polyamide, or any combination thereof. The treated water 144 is introduced into concentrated water 150 disposed in the first space. In various implementations, the RO device 146 actively induces greater than a threshold pressure within the first space. For instance, the RO device 146 includes a pump or other pressure-inducing device configured to induce a pressure of at least 2 bar, 5 bar, 10 bar, 20 bar, 40 bar, 60 bar, 80 bar, or 85 bar. As a result of the pressure in the first space, water within the concentrated water 150 flows through the membrane 148 and is output as purified water 152. The purified water 152, for instance, is permeate of the RO device 146. In various implementations, the purified water 152 has a salinity in a range of 0.0 mS/cm to 5.0 mS/cm or 0.0 mS/cm to 0.5 mS/cm. Thus, the purified water 152 may be suitable for irrigation, human consumption, or animal consumption. In some cases, purified water 152 is suitable as drinking water.

Although not specifically illustrated in FIG. 1, additional structures may be added to the desalination system 100. It has been observed that the temperature of the mixture 124 impacts the speed of the desalination process implemented by the desalination system 100. In some examples, the desalination system 100 includes one or more heaters (not illustrated) that increase a temperature of the mixture 124 above a lower threshold of 10, 15, 20, 25, or 30 degrees Celsius (° C.) (and below a boiling temperature), such as a temperature in a range of 17° C. to 35° C. In some cases, the desalination system 100 operates in an environment in which an ambient temperature is greater than 20, 25, or 30° C., such that the heater(s) may be unnecessary and/or deactivated.

According to various cases, fluids are propelled through the fluid circuit within the desalination system 100 via passive and/or active forces. In some examples, the desalination system 100 leverages hydrostatic pressure to propel the mixture 124 through the fluid circuit. For example, the saline water source 102 may store the saline at a higher altitude (with respect to gravity) than an outlet of the filter 142. In various cases, the water inlet 106 of the first desalination tank 104-a has a greater altitude than an outlet of the first desalination tank 104-a, such that the mixture 124 flows spontaneously through the first desalination tank 104-a. The inlets and outlets of the second to fourth desalination tanks 104-b to 104-d, for instance, may have similar relative altitudes. In some cases, the movement of fluids throughout the desalination system 100 are controlled through the fluid circuit via one or more pumps (not illustrated) and/or one or more valves (not illustrated).

In some examples, various components of the desalination system 100 are controlled by one or more processors (e.g., a controller, computing device, or the like). According to some examples, the processor(s) activate one or more of the components based on a predetermined schedule. For example, the processor(s) may cause a valve in the base of the settling tank 138 to open for a predetermined amount of time (e.g., ten minutes) at a predetermined frequency (e.g., every two hours).

In some cases, the processor(s) control the components of the desalination system 100 in response to conditions within the desalination system 100 and/or the saline water source 102. In some cases, one or more sensors (not illustrated) are disposed within the fluid circuit, communicatively coupled with the processor(s), and configured to detect at least one parameter of the desalination system 100. Examples of sensors include ORP sensors, temperature sensors, salinity sensors, pH sensors, pressure sensors, light sensors, and the like. Examples of parameters detected by the sensors include, for instance, temperature, salinity, pH, pressure, light absorbance, light transmittance, and the like. The processor(s), for instance, may selectively activate components of the desalination system 100 based on one or more parameters detected by the sensor(s). According to various cases, the processor(s) may activate or deactivate an example component in response to detecting that a parameter is above a first threshold or below a second threshold.

In various cases, the desalination system 100 is a hybrid system that has various advantages over systems that exclusively use RO to remove solutes from water. First, the purified water 152 can be produced with significantly less energy expenditure using the desalination system 100 as compared to a pure RO system. In various cases, the fluid circuit within the desalination system 100 can be operated in a substantially passive fashion, wherein the mixture 124 is substantially propelled through the fluid circuit using gravitational force. For instance, if the saline water source 102 is elevated with respect to the desalination tanks 104-a to 104-d and the filter 142, then the mixture 124 may spontaneously flow through the fluid circuit. In some cases, one or more pumps are also included to increase the flow of the mixture 124 through the fluid circuit. However, the energy utilized by the pump(s) may nevertheless be significantly lower than energy that would be utilized by a pump in a hypothetical RO system configured to purify the saline water directly.

Second, waste produced by the hybrid desalination system 100 is more easily managed than waste produced by a pure RO system. A hypothetical pure RO system would produce highly concentrated brine as a result of extracting permeate from the saline water. The salinity of the brine could be harmful to the environment if discharged without utilizing specialized disposal methods (e.g., deep-well injection) that can be costly and difficult. In contrast, the waste media 140 produced by the hybrid desalination system 100 can be easily converted to solid salt, which can be disposed of more easily than brine. In various cases, the particles 122 within the waste media 140 can additionally be recycled through the desalination system 100. Moreover, the concentrated water 150 produced by the operation of the RO device 146 can be recycled back through the desalination system 100. For instance, the concentrated water 150 can be discharged back into the fluid circuit of the desalination system 100 (e.g., into the saline water source 102, the first desalination tank 104-a, or the like) in order to remove additional salt from the concentrated water 150 into the waste media 140.

FIG. 2 illustrates an example environment 200 for controlling a desalination system, such as the desalination system 100 described above with reference to FIG. 1. The environment 200 includes one or more tanks 202 that accommodate a fluid circuit 204. For instance, the tank(s) 202 include the first desalination tank 104-a, the second desalination tank 104-b, the third desalination tank 104-c, the fourth desalination tank 104-d, the settling tank 138, the filter 142, or any combination thereof. The fluid circuit 204, in various cases, includes a hollow space that is disposed within the tank(s) 202. In some cases, the fluid circuit 204 includes one or more pipes, tubes, or other structures that connect multiple tanks among the tank(s) 202 together. A fluid, such as water (with or without dissolved solutes), a desalination media, a gas (e.g., air, oxygen, etc.), or any combination thereof, can be disposed in the fluid circuit 204. In some cases, the fluid flows through the fluid circuit 204. Although not specifically illustrated, in some cases, the fluid circuit 204 includes one or more inlets and/or one or more outlets.

In various implementations of the present disclosure, a desalination controller 206 is configured to analyze and/or cause modifications to conditions within the fluid circuit 204. In various cases, the desalination controller 206 is configured to optimize the conditions in the fluid circuit 204 to enhance efficient removal of one or more solutes from water disposed in the fluid circuit 204. In various implementations, the efficiency and rate of the capture of the dissolved salt within the water is dependent on the oxidation rate of the metal, therefore the rate of the oxidation reaction may be increased or decreased in order to enhance the desalination. In implementations, the desalination controller 206 may increase or decrease the rate of oxidation of the metal based on detecting a condition within the fluid circuit 204.

The desalination controller 206 can be embodied in software and/or hardware. For example, the desalination controller 206 includes at least one computing device, such as a server computer, a laptop, a tablet computer, a smart phone, or other type of computer. In various cases, the desalination controller 206 includes one or more processors configured to execute instructions. The instructions, for instance, are stored in memory and/or non-transitory computer-readable media. By executing the instructions, the desalination controller 206 performs various functions described herein.

In some cases, the desalination controller 206 is located on the premises of the desalination system. For instance, the desalination controller 206 could be packaged with the tank(s) 202 of the desalination system. In some cases, the desalination controller 206 is located remotely from the premises of the desalination system. For instance, the desalination controller 206, in some cases, is implemented in at least one server computer located at least one kilometer (km) away from the tank(s) 202.

Various sensors may be communicatively coupled to the desalination controller 206. As used herein, endpoints are “communicatively coupled,” if they are connected to one another via at least one wired (e.g., electrical, optical, etc.) interface and/or at least one wireless interface (e.g., BLUETOOTH™, cellular, near-field communication (NFC), etc.) over which communication signals can be transmitted between the endpoints. These sensors, in various cases, are configured to detect one or more parameters of the fluid circuit 204. These parameters include at least one of ORP, salinity, pH, temperature, pressure, light transmittance, or light reflectance, for example.

At least one ORP sensor 207, for instance, is disposed within the fluid circuit 204. The ORP sensor(s) 207 is configured to detect an ORP of water in one or more locations within the fluid circuit 204. Examples of the ORP sensor(s) 207 include, for instance, an electrical sensor configured to detect an electrical potential difference of the fluid in the fluid circuit 204. In various cases, the ORP sensor(s) 207 includes a reference electrode and a measuring electrode made of a noble metal, such as platinum or gold, that are suspended in the fluid. In some examples, the ORP sensor(s) 207 measure a voltage difference (e.g., mV) between the reference electrode and the measuring electrode, which changes based on the ORP of the water. In various implementations, the ORP sensor(s) 207 measurements are proportional to an amount of dissolved oxygen in the fluid.

At least one salinity sensor 208, for instance, is disposed within the fluid circuit 204. The salinity sensor(s) 208 is configured to detect a salinity level of water in one or more locations within the fluid circuit 204. Examples of the salinity sensor(s) 208 include, for instance, an electrical sensor configured to detect an electrical conductivity of the fluid in the fluid circuit 204. In various cases, the salinity sensor(s) 208 includes an anode and a cathode that are suspended in the fluid, as well as a power source that applies a voltage across the anode and the cathode. In some examples, the salinity sensor(s) 208 detects the electrical conductivity of the fluid by detecting an electrical current between the anode and the cathode. Alternatively, the salinity sensor(s) 208 includes a current source that outputs a current across the anode and the cathode, and then a voltage detector that detects the voltage between the anode and the cathode in order to detect the electrical conductivity of the fluid. In various implementations, the electrical conductivity is proportional to an amount of dissolved solute(s) in the fluid.

At least one pH sensor 210 is disposed in the fluid circuit 204, for example. The pH sensor(s) 210 is configured to detect a pH of the fluid at one or more positions in the fluid circuit 204. In some cases, the pH sensor(s) 210 include a pH electrode bulb including a membrane (e.g., including glass) that is permeable to H+ ions in the fluid. The pH sensor(s) 210 may further include a reference cell that contains a PH neutral electrolyte solution. An electrical sensor is connected to the pH electrode bulb and the reference cell and is configured to detect a voltage between the pH electrode bulb and the reference cell. If H+ ions in the fluid enter the pH electrode bulb, then a voltage is detected by the electrical sensor. The magnitude of the voltage, for instance, is dependent on an amount of H+ ions in the fluid, and is therefore indicative of the acidity of the fluid.

At least one temperature sensor 212 may be disposed in the fluid circuit 204. The temperature sensor(s) 212 is configured to detect the temperature of the fluid circuit 204 at one or more positions within the fluid circuit 204. Various types of temperature sensors can be utilized in the environment 200. According to various implementations, the temperature sensor(s) 212 include one or more thermocouples, thermistors, Peltier elements, or any combination thereof. In various examples, the temperature sensor(s) 212 is configured to output an electrical signal indicative of one or more detected temperatures by the temperature sensor(s) 212.

In some cases, one or more pressure sensor(s) 214 are disposed in the fluid circuit 204. The pressure sensor(s) 214 is configured to detect a pressure at one or more positions within the fluid circuit 204. In some cases, the pressure sensor(s) 214 include one or more capacitive and/or piezoelectric pressure sensors. For example, the pressure sensor(s) 214 include a membrane disposed between a space with a reference pressure and a space within the fluid circuit 204. When the pressure in the space within the fluid circuit 204 is different than the reference pressure, the membrane is configured to deform. In various implementations, the pressure sensor(s) 214 detects the pressure in the space based on an amount of deformation of the membrane. For instance, the capacitance of a capacitor including the membrane as a plate, or an electrical signal output by the membrane (e.g., due to the piezoelectric effect), is indicative of the deformation of the membrane and the pressure in the space.

According to some examples, one or more light sensors 216 are disposed in the fluid circuit 204. In some cases, the light sensor(s) 216 include one or more light sources (e.g., light-emitting diodes (LEDs)) and one or more light detectors (e.g., photodiodes, phototransistors, etc.) configured to detect light emitted by the light source(s). In some cases, the fluid in the fluid circuit 204 is physically disposed between the light source(s) and the light detector(s). An amount of light detected by the light detector(s), for example, is dependent on an amount of the light that is transmitted (e.g., not absorbed) by the fluid in the fluid circuit 204. In some examples, the light detector(s) is configured to detect an amount of light that is both emitted by the light source(s) and reflected by the fluid in the fluid circuit 204. In some cases, a frequency of the light emitted by the light source(s) and detected by the light detector(s) is optimized for absorbance and/or reflectance of a particular material (e.g., oxidized particles) in the fluid disposed in the fluid circuit 204. For example, the absorbance of the light of an aqueous solution of the oxidized nanoparticles at a predetermined concentration may be greater than a predetermined threshold. In various cases, the light detector(s) output an electrical signal indicative of an amount of light absorbed and/or reflected by the fluid in the fluid circuit 204. This signal may be indicative of an amount of the material present in the fluid in the fluid circuit 204.

The desalination controller 206, in various cases, receives signals from the salinity sensor(s) 208, the pH sensor(s) 210, the temperature sensor(s) 212, the pressure sensor(s) 214, the light sensor(s) 216, or any combination thereof, that are indicative of parameters detected by the respective sensors. In some cases, the signals include one or more analog signals, and the desalination controller 206 includes one or more analog-to-digital converters (ADCs) configured to convert the signals into digital signals indicative of the detected parameters. In some cases, the signals output by the sensors include digital signals that are indicative of the detected parameters. In various cases, the desalination controller 206 is configured to analyze data (e.g., in the form of digital signals) indicative of the detected parameters.

In various implementations, the desalination controller 206 is communicatively coupled to one or more active elements that are configured to change conditions within the fluid circuit 204. The desalination controller 206, for instance, is configured to output one or more signals (also referred to as “control signals”) to the active elements in order to cause changes to conditions within the fluid circuit 204.

In various cases, one or more pumps 218 are present in the fluid circuit 204. The pump(s) 218, in various cases, are configured to control pressure differentials between different subspaces in the fluid circuit 204, thereby inducing fluid flow within the fluid circuit 204. The pump(s) 218, for instance, include at least one peristaltic pump, at least one centrifugal pump, at least one diaphragm pump, at least one magnetic pump, or any combination thereof. In some cases, the pump(s) 218 can include one or more propellers configured to cause fluid movement within the fluid circuit 204.

According to some implementations, one or more valves 220 are present in the fluid circuit 204. The valve(s) 220, for instance, are configured to selectively open or close portions of the fluid circuit 204 to fluid flow. In various cases, the valve(s) 220 include check valves, ball valves, butterfly valves, or any combination thereof. Notably, the valve(s) 220 may include at least one valve configured to control liquid (e.g., saline and/or desalination media slurry) flow in the fluid circuit 204 and/or to control gas (e.g., air) flow in the fluid circuit 204.

In various cases, one or more heaters 222 are present in the fluid circuit. The heater(s) 222, for instance, are configured to heat portions of the fluid circuit 204. In some cases, the heater(s) 222 include one or more resistive elements that output heat when a voltage is applied. In some cases, the heater(s) 222 include one or more Peltier elements.

In some examples, the pump(s) 218 and/or valve(s) 220 are configured to control the flow of fluid between the fluid circuit 204 and one or more external spaces (e.g., receptacles). These external spaces may include a gas source 224 (e.g., the gas source 132), a desalination media source 226 (e.g., the desalination media source 118), a saline water source 228 (e.g., the saline water source 102), a buffer source 230, and one or more waste receptacles 232. In various cases, the gas source 224 is a space that contains a gas (e.g., air and/or oxygen). The desalination media source 226, for instance, is a space that contains desalination media (e.g., nano media slurry). In some examples, the saline water source 228 includes saline water that is to be desalinated by the desalination system. In various cases, the buffer source 230 is a space that includes a buffer solution (e.g., a bicarbonate solution) that can be used to adjust the pH within the fluid circuit 204. In various examples, the waste receptacle(s) 232 includes a space that is configured to receive waste media and/or captured solute(s) from the fluid in the fluid circuit 204. These external spaces, for instance, include one or more tanks, tubs, or other containers that are fluidly and selectively coupled to the fluid circuit 204.

In various implementations of the present disclosure, the desalination controller 206 is configured to control the pump(s) 218, the valve(s) 220, the heater(s) 222, or any combination thereof, based on one or more parameters detected by the salinity sensor(s) 208, the pH sensor(s) 210, the temperature sensor(s) 212, the pressure sensor(s) 214, the light sensor(s) 216, or any combination thereof. For example, the desalination controller 206 may output a control signal that activates or deactivates the pump(s) 218, the valve(s) 220, the heater(s) 222, or any combination thereof, in response to determining that one or more parameters are above a first threshold and/or below a second threshold.

In particular cases, the desalination controller 206 controls the pump(s) 218 and/or the valve(s) 220 in response to detecting that a salinity detected by the salinity sensor(s) 208 is above a threshold. In some examples, the desalination controller 206 causes the pump(s) 218 to recirculate fluid in the fluid circuit 204 until the salinity is below the threshold. In some examples, the desalination controller 206 causes the valve(s) 220 to block the fluid from being discharged (e.g., into a filter, such as the filter 142, or into a settling tank, such as the settling tank 138) until the salinity is above the threshold. In some cases, the desalination controller 206 causes the pump(s) 218 and/or valve(s) 220 to release desalination media from the desalination media source 226 in response to detecting that the salinity is above the threshold. In some examples, the desalination controller 206 causes the pump(s) 218 and/or valve(s) 220 to release saline water from the saline water source 228 into the fluid circuit 204 in response to detecting that the salinity is below the threshold.

According to some cases, the desalination controller 206 controls conditions within the fluid circuit 204 based on a pH detected by the pH sensor(s) 210. In some examples, the desalination media has a relatively low pH (e.g., due to the presence of phenols added to the desalination media during particle synthesis). It has been observed that the efficiency and speed by which the desalination media removes solute(s) from saline can be enhanced by lowering the pH of the saline added to the fluid circuit 204. In some examples, the desalination controller 206 causes the pump(s) 218 and/or valve(s) 220 to release buffer (e.g., water containing bicarbonate or some other type of basic solution) from the buffer source 230 into the fluid circuit 204 in response to detecting that the pH detected by the pH sensor(s) 210 is below a threshold.

In some examples, the desalination controller 206 adjusts conditions within the fluid circuit 204 based on a temperature detected by the temperature sensor(s) 212. In various implementations, it has been observed that the efficiency and speed by which the desalination media removes solute(s) from saline can be enhanced by controlling the temperature of the fluid in the fluid circuit 204 to be in a range of 25° C. to 50° C. In various cases, the desalination controller 206 causes the heater(s) 222 to activate in response to determining that a temperature detected by the temperature sensor(s) 212 is below a threshold.

In various instances, the desalination controller 206 adjusts the conditions within the fluid circuit 204 based on a pressure detected by the pressure sensor(s) 214. A pressure differential between different locations along the fluid circuit 204 may be indicative of an amount of fluid flow in the fluid circuit 204. In some cases, an initial phase of flow through the fluid circuit 204 is achieved via hydrostatic flow from the saline water source 228 into the fluid circuit 204, wherein the saline water source 228 may be elevated with respect to the fluid circuit 204. However, after a sufficient amount of saline water has left the saline water source 228, in some cases, pressure in the fluid circuit 204 may equilibrate, causing limited to nonexistent fluid flow. In some examples, the desalination controller 206 activates the pump(s) 218 to activate in response to determining that a difference between a pressure detected at a first part of the fluid circuit 204 and a pressure detected at a second part of the fluid circuit 204 is below a threshold.

According to some cases, the desalination controller 206 may cause the valve(s) 220 to selectively vent gasses in the fluid circuit 204 to an environment outside of the fluid circuit 204. For instance, if the fluid circuit 204 is sealed from an external environment, and the gas source 224 releases gas into the fluid circuit 204, the pressure within the fluid circuit 204 may build to an undesirable level. In various cases, the desalination controller 206 causes the valve(s) 220 to vent fluid in the fluid circuit 204 to the external environment in response to detecting that a pressure detected by the pressure sensor(s) 214 is above a threshold.

In some examples, the desalination controller 206 selectively causes removal of waste media and/or solute from fluid in the fluid circuit 204. In particular examples, particles capture solute from the fluid during oxidation. The oxidation of particles in the fluid, in various cases, changes the absorbance and/or reflectance of the fluid. For instance, oxidized nanoparticles can cause treated water to appear opaque and/or as an orange color. In various cases, the desalination controller 206 causes the pump(s) 218 and/or valve(s) 220 to release waste media and solute from the fluid circuit 204 and into the waste receptacle(s) 232 in response to determining that a light absorbance and/or reflectance of the fluid in the fluid circuit 204 exceeds a first threshold and/or that a light transmittance of the fluid in the fluid circuit 204 is below a second threshold. The desalination controller 206, in various implementations, determines the light absorbance, reflectance, or transmittance based on signals output by the light sensor(s) 216.

An RO device 234 may be configured to receive treated water from the fluid circuit 204. In some implementations, the desalination controller 206 further controls the pump(s) 218 to induce greater than a threshold pressure on a side of a membrane of the RO device 234, which may cause the RO device 234 to generate purified water by removing an additional amount of solute(s) from the treated water. In various cases, the desalination controller 206 is further configured to cause the pump(s) 218 to move brine from the side of the membrane of the RO device 234 to fluid circuit 204 and/or the saline water source 228.

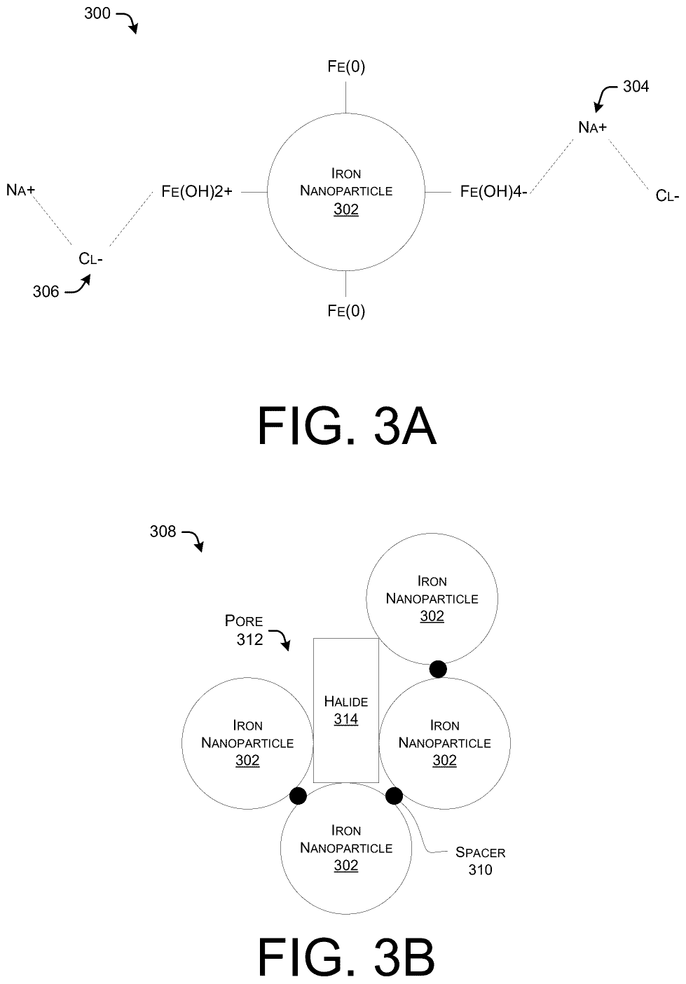

FIGS. 3A and 3B illustrate examples of iron nanoparticles configured to adsorb sodium (Na) and chlorine (Cl) atoms. FIG. 3A illustrates an example environment 300 in which an iron nanoparticle 302 captures a sodium ion (Na+) 304 and a chlorine ion (Cl−) 306. Although FIGS. 3A and 3B are described with reference to removing sodium and chlorine ions, it should be understood that in some cases, other positive and negative ions can be removed from water using similar techniques.

The iron nanoparticle 302 may include ZVI (Fe(0). According to various implementations, the iron nanoparticle 302 may have a mean particle size that is less than 1000 nm. For instance, the mean particle size can be calculated by observing a sample of iron nanoparticles under a microscope, measuring lengths of the iron nanoparticles in at least one direction, and then calculating an arithmetic mean of the lengths. For instance, an AMSCOPE 3.5×-180× Light Emitting Diode (LED) Zoom Digital Stereo Microscope with a 10 MP camera could be used to capture an image of the particles (e.g., in or out of solution). Image processing software can be used to perform point counting (e.g., software provided by National scientific and Technical Research Council, Buenos Aries, Argentina). The point counting software may also be used to identify the diameters of the particles.

In some cases, a length (e.g., a diameter) of the iron nanoparticle 302 may be between 10 and 100 nm, 20 to 80 nm, or 35 to 55 nm. In various implementations, the iron nanoparticle 302 may have a surface area between about 0.1 square meters per gram (m2/g) to about 25 m2/g. As used herein, the term “about” can refer to a range of numbers that would be rounded to the number specified. For instance, the term “about 0.1” may refer to a range of 0.05 to 0.14.

In some cases, when the iron nanoparticle 302 begins to corrode (i.e., oxidize), iron on the surfaces of the particles is hydrolyzed, and hydroxyl (—OH) groups are formed on the surfaces of the particles. The hydroxyl groups on the surfaces are amphoteric, and can have a negative charge or a positive charge depending on a pH of the solution.

According to some implementations, at least some of the ZVI on the surface of the iron nanoparticle 302 can be oxidized while immersed in water. When the ZVI becomes oxidized, two types of complexes may be formed: FeOOH2+ and FeOOH−. The positively charged FeOOH2+ may electrostatically attract the negatively charged Cl− 306 dissolved in the water. The negatively charged FeOOH− may electrostatically attract the positively charged Na+ 304 dissolved in the water. The electrostatic attraction between the charged complexes and the Cl− 306 and Na+ 304 ions may cause a first layer of Cl− 306 and Na+ 304 ions to be adsorbed onto the surface of the iron nanoparticle 302.

Once a first layer of Na+ 304 and Cl− 306 is adsorbed onto the surface of the iron nanoparticle 302, additional ions may be further adsorbed onto the first layer. For instance, additional negatively charged Cl− ions 306 may be electrostatically attracted to the positively charged Na+ 304 in the first layer, and additional positively charged Na+ 304 may be electrostatically attracted to the negatively charged Cl− 306 in the first layer. Multiple layers of Cl− 306 and Na+ 304 may assemble on the surface of the iron nanoparticle 302. In some cases, the Cl− 306 and Na+ 304 may form a crystal structure.

The adsorption of the Na+ 304 and Cl− 306 due to electrostatic forces with oxidized forms of iron in the nanoparticle 302 may occur relatively quickly. As Cl− 306 is attracted to, and attaches to, Fe(OH)4+ functional groups on the surface of the iron nanoparticle 302, a subsequent, slower reaction may take place that also causes desalination. In some examples, the Cl− 306 may further catalyze the oxidation of Fe(0) in the iron nanoparticle 302. Additional Cl− 306 may diffuse through the surface layer of the iron nanoparticle 302 and cause further oxidation of the Fe(0) below the outer surface of the iron nanoparticle 302 and within the interior of the iron nanoparticle 302. Additional layers of Fe—O—Cl and Fe—O—Na may be generated within the interior of the iron nanoparticle 302.

Both reactions (the surface adsorption and capture by iron within the interior of the iron nanoparticle 302) may cause water uptake. In addition, when the iron nanoparticle 302 is submerged in water, the salinity gradient may increase as a distance to the iron nanoparticle 302 decreases, due to the capture of the Na+ 304 and the Cl− 306. Accordingly, a nano media including iron nanoparticles 302 may aggregate into solid particles that expand in size, due to water uptake and osmosis, when exposed to saline.

In various implementations, the efficiency and rate of the capture of the Na+ 304 and the Cl− 306 is dependent on the oxidation rate of the Fe(0). In various cases, it may be beneficial to increase or decrease the rate of the oxidation reaction in order to enhance the desalination reaction (i.e., the capture of the Na+ 304 and the Cl− 306). Various conditions indicating that it would be beneficial to increase or decrease the rate of oxidation are described herein, such as a temperature of the water, an ORP of the water, a pH of the water, a concentration of the dissolved salt in the water, an amount of the metal, or a valency state of the metal. Various techniques for increasing or decreasing the rate of oxidation are also described in the herein.

FIG. 3B illustrates an example environment 308 of multiple iron nanoparticles 302 capturing Na and Cl dissolved in water. The multiple iron nanoparticles 302 may be packed together. In some cases, spacers 310 may be disposed between the iron nanoparticles 302. Some examples of spacers 310 include a starch (e.g., potato starch), carboxy methyl cellulose, polyvinyl pyrrolidine, or the like. The spacers 310 may prevent the iron nanoparticles 302 from agglomerating. Although not illustrated, in some cases, at least some of the iron nanoparticles 302 may be directly touching each other.

In various implementations, a pore 312 can be present between the iron nanoparticles 302. In some cases, multiple pores 312 can be present between groups of the iron nanoparticles 302. The pore 312 may be generated based on the geometries of the iron nanoparticles 302 and the spacers 310. In various examples, the pore 312 may have a width of 20-100 nm.

When the iron nanoparticles 302 are exposed to water in which chlorine and sodium atoms are dissolved, the sodium and chlorine atoms may be adsorbed onto the surfaces of the iron nanoparticles 302. In some cases, the sodium and chlorine atoms may assemble into a halide 314 disposed within the pore 312. The halide 314 may be a crystal including the sodium and chlorine atoms.

In various implementations, the iron nanoparticles 302 can remove a significant amount of salt from water. For example, in the case of Na and Cl removal from water, a ratio of a weight or mass of Na and Cl removed from saline water by the iron nanoparticles 302 to a weight or mass of iron in the iron nanoparticles 302 (i.e., NaCl:Fe) can be as much as 20:1.

In some cases, additional contaminants can be removed from the water by the iron nanoparticles 302. For example, various other solutes described herein can also be captured by the iron nanoparticles 302.

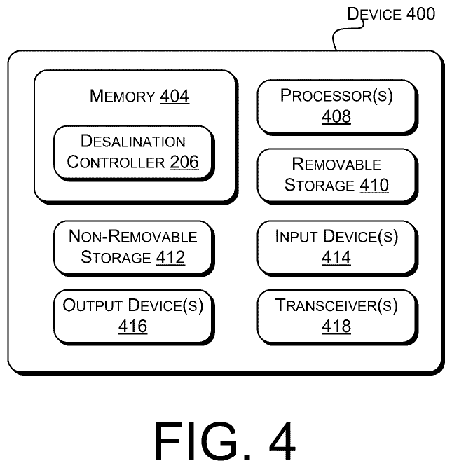

FIG. 4 illustrates at least one example device 400 configured to enable and/or perform various functionality discussed herein. Further, the device(s) 400 can be implemented as one or more server computers, a network element on a dedicated hardware, as a software instance running on a dedicated hardware, or as a virtualized function instantiated on an appropriate platform, such as a cloud infrastructure, and the like. It is to be understood in the context of this disclosure that the device(s) 400 can be implemented as a single device or as a plurality of devices with components and data distributed among them.

As illustrated, the device(s) 400 comprise a memory 404. In various implementations, the memory 404 is volatile (including a component such as Random Access Memory (RAM)), non-volatile (including a component such as Read Only Memory (ROM), flash memory, etc.) or some combination of the two.

The memory 404 may include various components, such as instructions for executing various functions of the desalination controller 206. The memory 404 can store methods, threads, processes, applications, or any other sort of executable instructions. The memory 404 can also store files and/or databases.

The memory 404 may include various instructions (e.g., instructions of the desalination controller 206), which can be executed by at least one processor 408 to perform operations. In some cases, the processor(s) 408 includes a Central Processing Unit (CPU), a Graphics Processing Unit (GPU), or both CPU and GPU, or other processing unit or component known in the art.

The device(s) 400 can also include additional data storage devices (removable and/or non-removable) such as, for example, magnetic disks, optical disks, or tape. Such additional storage is illustrated in FIG. 4 by removable storage 410 and non-removable storage 412. Tangible computer-readable media can include volatile and nonvolatile, removable and non-removable media implemented in any method or technology for storage of information, such as computer readable instructions, data structures, program modules, or other data. The memory 404, removable storage 410, and non-removable storage 412 are all examples of computer-readable storage media. Computer-readable storage media include, but are not limited to, RAM, ROM, EEPROM, flash memory or other memory technology, CD-ROM, Digital Versatile Discs (DVDs), Content-Addressable Memory (CAM), or other optical storage, magnetic cassettes, magnetic tape, magnetic disk storage or other magnetic storage devices, or any other medium which can be used to store the desired information and which can be accessed by the device(s) 400. Any such tangible computer-readable media can be part of the device(s) 400.

The device(s) 400 also can include input device(s) 414, such as a keypad, a cursor control, a touch-sensitive display, voice input device, one or more sensors, and the like. In various cases, the device(s) 400 include output device(s) 416 such as a display, speakers, printers, one or more active elements (e.g., pumps, valves, heaters, etc.), and the like. In particular implementations, a user can provide input to the device(s) 400 via a user interface associated with the input device(s) 414 and/or the output device(s) 416.

As illustrated in FIG. 4, the device(s) 400 can also include one or more wired or wireless transceiver(s) 418. For example, the transceiver(s) 418 can include a Network Interface Card (NIC), a network adapter, a LAN adapter, or a physical, virtual, or logical address to connect to the various base stations or networks contemplated herein, for example, or the various user devices and servers. To increase throughput when exchanging wireless data, the transceiver(s) 418 can utilize Multiple-Input/Multiple-Output (MIMO) technology. The transceiver(s) 418 can include any sort of wireless transceivers capable of engaging in wireless, Radio Frequency (RF) communication. The transceiver(s) 418 can also include other wireless modems, such as a modem for engaging in Wi-Fi, WiMAX, Bluetooth, or infrared communication. In some implementations, the transceiver(s) 418 can be used to communicate between various functions, components, modules, or the like, that are comprised in the device(s) 400.

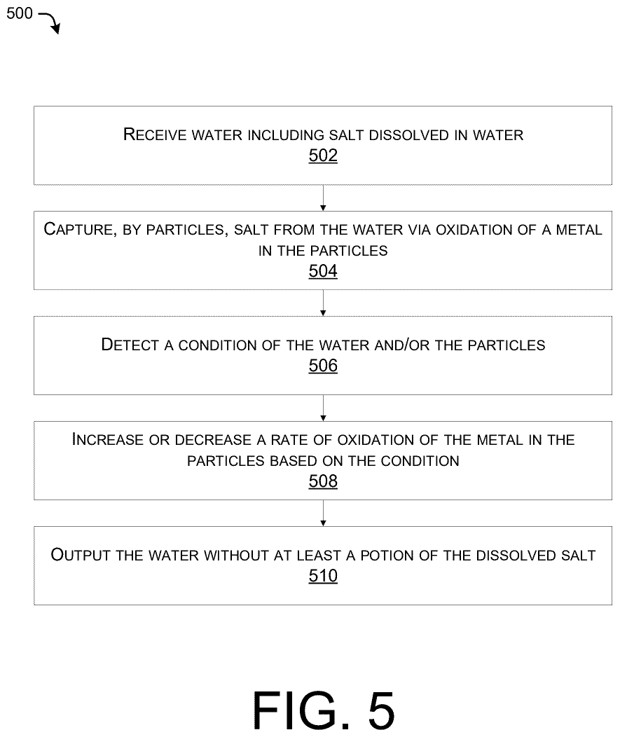

FIG. 5 illustrates an example process 500 for removing solutes from an aqueous solution. In implementations, the process 500 can be performed in a desalination system, such as the desalination system 100, and can be controlled by a desalination controller, such as desalination controller 206, and in a manner consistent with FIG. 2.

At 502, the process 500 includes receiving water including a dissolved salt. For example, the water can include seawater, saline, brine, industrial waste, mining waste, agricultural waste, produced water, flowback, other types of aqueous solutions, or any combination thereof. In the illustrated process, 500, the dissolved salt includes sodium ions and chloride ions. In implementations, the dissolves salts can also include dissolved ions, such as at least one of magnesium, sodium, chloride, phosphate, sulfate, arsenic, nitrate, nitrite, or hypochlorite. In various implementations, the process 500 can be used to remove solute(s) from an aqueous solution, including one or more metals, such as at least one of copper, zinc, magnesium, manganese, aluminum, selenium, or one or more radionuclides.

At 504, the process 500 includes capturing, by particles, the salt from the water via oxidation of a metal in the particles. In implementations, the particles can include nanoparticles. In some cases, the metal can include iron (e.g., zero-valent iron (ZVI)), copper, aluminum, magnesium, manganese, zinc, or combinations thereof. The metal in the particles can be oxidized when it reacts with an oxidizing species (e.g., oxygen gas, ozone, etc.) to form other valency states, such as a (II) state and/or a (III) state. For example, ZVI, can be oxidized to form other valency states, such as Fe(II) and/or Fe(III). In particular cases, the particles include an oxyhydroxide, such as Fe(III) oxyhydroxide, (FeO(OH)).

At 506, the process 500 includes detecting a condition of the water and/or the particles. In implementations, the condition includes at least one of a temperature of the water, an ORP of the water, a pH of the water, a concentration of the dissolved salt in the water, an amount of the metal, and a valency state of the metal. In implementations, the condition of the water and/or the particles can be detected multiple times to provide information about the condition over time, such as a rate of change of the condition. For example, the concentration of the dissolved salt in the water can include a rate of change of the concentration of the dissolved salt in the water, which can indicate an efficiency of the process 500 for removing the dissolved salts from the water.

In implementations, the condition can include an amount of the metal having a first valency state and/or an amount of the metal having a second valency state. For example, the first valency state can be a (II) state and the second valency state can be a (III) state, or the first valency state can be a (0) state and the second valency state can be a (II) state. In some cases, the condition can include an amount of the metal in the water that is in a valency state that is lower than a (III) state. Detecting the valency state of the metal in the water can indicate the desalination potential of the process 500, and detecting how much of the metal in the water that is in each valency state can inform the operation of the process 500, for example to improve efficiency. In implementations, an amount of metal in the water and the valency state of the metal in the water can inform decisions such as whether to remove metal particles from the process 500, recycle metal particles within the process 500, or add metal particles to the process 500.

At 508, the process 500 includes, based on the condition of the water and/or the particles, increasing or decreasing a rate of the oxidation of the metal in the particles. In various implementations, the efficiency and rate of the capture of the dissolved salt within the water is dependent on the oxidation rate of the metal. In various cases, it may be beneficial to increase or decrease the rate of the oxidation reaction in order to enhance the desalination reaction (i.e., the capture of the salt ions such as Na+ and Cl−). Various conditions indicating that it would be beneficial to increase or decrease the rate of oxidation are described herein. Various techniques for increasing or decreasing the rate of oxidation are also described herein.

In implementations, increasing the rate of the oxidation can include, alone or in combination, adding an oxidizing agent to the water or increasing a temperature of the water. In implementations, the oxidizing agent can include at least one of oxygen, ozone, a peroxide, a hypochlorite, a perchlorate, a permanganate, nitric acid, or potassium dichromate. For example, the oxygen can include oxygen from air, the peroxide can include hydrogen peroxide, the hypochlorite can include sodium hypochlorite, the perchlorate can include sodium perchlorate, and the permanganate can include potassium permanganate. In implementations, increasing a temperature of the water may increase the rate of the oxidation of the metal in the particles. In some cases, increasing or decreasing a temperature of the water within processes of the present disclosure, such as process 500, may have variable effects on oxidation of the metal and on removal of solutes from the water. For example, the effect of increasing or decreasing a temperature of the water may be dependent on the starting temperature of the water. In some cases, the temperature of the water may have a variable effect on oxidation and removal of solutes as the temperature approaches the boiling point of the water or the freezing point of the water.

In implementations, decreasing the rate of the oxidation of the metal in the particles can include, either alone or in combination, reducing an amount of oxygen in the water, decreasing a temperature of the water, adding a reducing agent to the water, adding a sulfide and/or sulfate to the water, or increasing a volume of the water in a fluid circuit enclosing the particles. In implementations, reducing the amount of oxygen in the water can include, alone or in combination, adding nitrogen bubbles in the water, introducing oxygen consuming microorganisms to the water, or increasing a respiration rate of microorganisms in the water. In implementations, adding nitrogen gas (N₂) bubbles to the water can be used to expel oxygen from water without participating in the oxidation reaction. Adding nitrogen gas (N₂) bubbles in effect creates anoxic conditions which can enhance desalination. In implementations, introducing oxygen consuming microorganisms and/or increasing a respiration rate of oxygen consuming microorganisms can reduce the amount of oxygen in the water. For example, sulfate reducing bacteria can be used and would not only consume oxygen but can eliminate sulfate as well. Increasing a respiration rate of oxygen consuming microorganisms can include adding a nutrient source, such as glucose or sucrose, to the water. In implementations, the process 500 can include additional steps to remove microorganisms from the water as needed. For example, the water can be passed through one or more filters, such as a sand filter, activated carbon, and a membrane filter. Membrane filters can include microfiltration, ultrafiltration, and reverse osmosis. The water can also be disinfected to kill the oxygen consuming microorganisms, for example with chlorine, iodine, ultraviolet (UV) light, or ozone gas.

In implementations, reducing an amount of oxygen in the water may change the ORP of the water. As can be seen in FIG. 6, the ORP of water within processes of the present disclosure, such as process 500, shows a nonlinear effect on desalination. Therefore, reducing or increasing an amount of oxygen in the water may have an effect to both increase and decrease desalination of the water depending on multiple factors.

In implementations, decreasing a temperature of the water may decreasing the rate of the oxidation of the metal in the particles. In some cases, increasing or decreasing a temperature of the water within processes of the present disclosure, such as process 500, may have variable effects on oxidation of the metal and on removal of solutes from the water. For example, the effect of increasing or decreasing a temperature of the water may be dependent on the starting temperature of the water. In some cases, the temperature of the water may have a variable effect on oxidation and removal of solutes as the temperature approaches the boiling point of the water or the freezing point of the water.

In implementations, adding a reducing agent to the water can reduce amount of oxygen in the water. Examples of the reducing agent, in various cases, include nitrogen gas, an oxygen-consuming microorganism, a nitride, a nitrate, calcium, barium, sodium borohydride, an alcohol, a phenol, uric acid, urea, tartaric acid, maleic acid, or tannic acid.

In implementations, adding a sulfide and/or sulfate to the water can decrease the rate of oxidation of the metal. In some cases, both sulfide and sulfate can inhibit oxidation within the process 500. Sulfide may consume the media by reacting with the metal in the particles and therefore renders the metal unavailable for capturing dissolved salts within the water, reducing the rate of oxidation of the metal. The effect of sulfate effect is more dependent on the content of salt ions, such as Cl−, in the water. For example, if a Cl− to SO42− ratio is less than about 5, the reaction can be inhibited.

In implementations, increasing a volume of the water in a fluid circuit enclosing the particles can decrease the rate of oxidation of the metal. For example, increasing a volume of the water in the fluid circuit can alter the concentration of the metal in the water and/or the ratio of metal to solutes in the water. In implementations, reducing the ratio of metal to solutes in the water can decrease the rate of oxidation of the metal.

At 510, the process 500 includes outputting the water without at least a portion of the dissolved salt. In some cases, the process 500 can remove at least 75% of an amount of one or more solutes (e.g., salt) from the aqueous solution. In some cases, at least 80% of the solute(s) can be removed from the aqueous solution. For example, seawater, saline, brine, and other types of aqueous solutions can be treated using various implementations of process 500 described herein, in order to yield treated water that may be suitable for irrigation uses and/or for human consumption.

The efficiency of the process 500 can be impacted by the amount of solute(s) in the original aqueous solution, the amount of particles in the desalination media, the amount of metal in the desalination media relative to the volume of the aqueous solution, the amount of time the particles are present in a mixture with the aqueous solution prior to particle removal, the amount of oxidizing gas introduced into the mixture, the pH of the mixture, features of a desalination system that facilitates the desalination process, and other characteristics of implementations of the process described herein.

FIG. 6 illustrates observed desalination as a function of ORP, and the effect of ORP (mV) on desalination outcomes. ORP is a measure of a solution's capacity to either donate or accept electrons. It indicates whether a substance in a solution is more likely to oxidize (lose electrons) or reduce (gain electrons). A positive ORP suggests the solution provides oxidizing conditions, meaning it has a greater tendency to accept electrons and a substance within the solution is more likely to oxidize. A negative ORP suggests the solution provides reducing conditions, meaning it has a greater tendency to donate electrons and a substance within the solution is more likely to reduce. The graph of FIG. 6 was generated by adjusting the ORP of the water either by adding air to increase the ORP or by adding calcium (Ca) or organic material to decrease the ORP, and then measuring the resulting % desalination

A parabolic curve can be observed in FIG. 6, where the lowest % desalination is shown at an OPR of about 250 mV. The % desalination is shown to increase at ORP values both above and below about 250 mV. This suggests that within systems of the present disclosure, the % desalination and the rate of desalination of water in the system are dependent on multiple factors, including the ORP of the water and the dominant oxidation state or rate of oxidation of metal particles within the water.

In various implementations, techniques for controlling the rate of oxidation and/or the dominant oxidation state of the metal are described herein. For example, certain oxidation states in the iron of ZVI nanoparticles during desalination can enhance the efficiency and/or rate of the desalination reaction. Other conditions may also impact the desalination reaction. It may be beneficial, in some cases, to increase or decrease the rate of oxidation within a desalination reactor (e.g., a desalination tank) in order to enhance the desalination reaction.

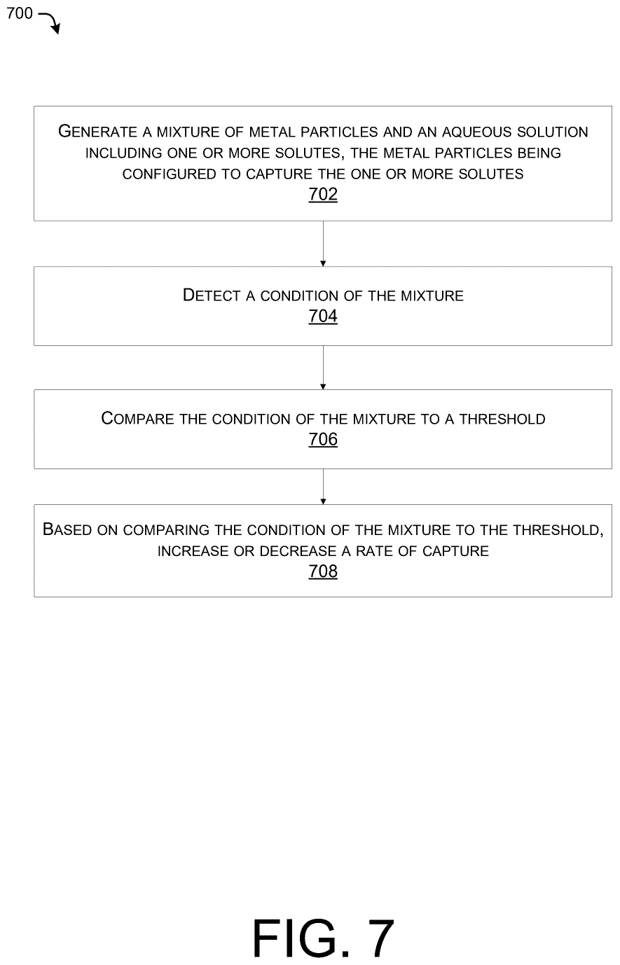

FIG. 7 illustrates an example process 700 for capturing solutes from an aqueous solution. The process 700 may be performed by an entity, such as a desalination system, at least one processor, a computing device, one or more desalination tanks (also referred to as “desalination reactors”), or any combination thereof.

At 702, the process 700 includes generating a mixture of metal particles and an aqueous solution including one or more solutes. In implementations, the metal particles are configured to capture the one or more solutes by undergoing an oxidation reaction. In implementations, the metal particles can include nanoparticles. In some cases, the metal particles include at least one zero valency metal and the metal particles can include at least one of iron, zinc, copper, aluminum, magnesium, or manganese. Tin implementations, the one or more solutes can include at least one of sodium ions, copper ions, zinc ions, magnesium ions, manganese ions, aluminum ions, arsenic ions, chloride ions, selenium ions, phosphate ions, sulfate ions, nitrate ions, nitrite ions, or hypochlorite ions.

At 704, the process 700 includes detecting a condition of the mixture. In implementations, the condition includes the ORP of the mixture, a pH of the mixture, or an amount of the metal particles having a predetermined valency state after undergoing the oxidation reaction. In some cases, the valency state includes a (II) state or a (III) state.

At 706, the process 700 includes comparing the condition of the mixture to a threshold. In some cases, the condition is an OPR measurement and the threshold includes an ORP value of about 250 mV.

At 708, the process 700 includes, based on comparing the condition of the mixture to the threshold, increasing a rate that the metal particles capture the one or more solutes in the mixture by increasing or decreasing an ORP of the mixture. In implementations, increasing the rate that the metal particles capture the one or more solutes in the mixture includes decreasing the ORP of the mixture. In some cases, decreasing the ORP of the mixture includes adding or increasing a level of a reducing agent in the mixture. The reducing agent can include at least one of calcium, an oxygen-consuming microorganism, a nitride, a nitrate, sodium borohydride, an alcohol, or a phenol. In some cases, decreasing the ORP of the mixture includes decreasing a temperature of the mixture and/or injecting nitrogen gas into the mixture.

In implementations, increasing the rate that the metal particles capture the one or more solutes in the mixture includes increasing the ORP of the mixture. In some cases, increasing the ORP of the mixture can include increasing a temperature of the mixture and/or adding or increasing a level of an oxidizing agent in the mixture. The oxidizing agent can include at least one of air, oxygen gas, hydrogen peroxide, sodium hypochlorite, sodium perchlorate, or potassium permanganate.

The process 700 can also include removing at least a portion of the one or more solutes captured by the metal particles from the mixture by removing the metal particles from the mixture.

### EXAMPLE CLAUSES

The following Clauses provide various examples of the present disclosure. However, implementations of the present disclosure are not limited to the Clauses listed herein.

1. A system, including: one or more desalination tanks configured to receive an aqueous solution including water, sodium ions, and chloride ions; a desalination media source configured to generate a mixture of the aqueous solution and a desalination media by outputting a desalination media into the one or more desalination tanks, the desalination media including metal nanoparticles configured to capture the sodium ions and the chloride ions by undergoing oxidation; an oxidation-reduction potential (ORP) sensor configured to detect an ORP of the mixture; a redox agent source; and a processor configured to: compare the ORP of the mixture to a threshold; and based on comparing the ORP of the mixture to the threshold, increasing a rate at which the metal nanoparticles capture the sodium ions and the chloride ions by causing the redox agent source to: output a redox agent into the one or more desalination tanks; or increase a level of the redox agent in the mixture.
2. The system of clause 1, wherein the processor is configured to compare the ORP of the mixture to the threshold by determining that the ORP of the mixture is above the threshold, and wherein the redox agent includes a reducing agent, the reducing agent including at least one of nitrogen gas, an oxygen-consuming microorganism, a nitride, a nitrate, or calcium.
3. The system of clause 1 or 2, wherein the processor is configured to compare the ORP of the mixture to the threshold by determining that the ORP of the mixture is below the threshold, and wherein the redox agent includes an oxidizing agent, the oxidizing agent including at least one of air, oxygen gas, hydrogen peroxide, sodium hypochlorite, sodium perchlorate, or potassium permanganate.
4. A method, including: generating a mixture of metal particles and an aqueous solution including one or more solutes, the metal particles being configured to capture the one or more solutes by undergoing an oxidation reaction; detecting a condition of the mixture; comparing the condition of the mixture to a threshold; based on comparing the condition of the mixture to the threshold, increasing a rate that the metal particles capture the one or more solutes in the mixture by increasing or decreasing an ORP of the mixture.
5. The method of clause 4, wherein the metal particles include nanoparticles.
6. The method of clause 4 or 5, wherein the metal particles include at least one zero valency metal.
7. The method of any of clauses 4 to 6, wherein the metal particles include at least one of iron, zinc, copper, aluminum, magnesium, or manganese.
8 The method of any of clauses 4 to 7, wherein the one or more solutes include at least one of sodium ions, copper ions, zinc ions, magnesium ions, manganese ions, aluminum ions, arsenic ions, chloride ions, selenium ions, phosphate ions, sulfate ions, nitrate ions, nitrite ions, or hypochlorite ions.
9. The method of any of clauses 4 to 8, wherein the condition includes the ORP of the mixture, a pH of the mixture, or an amount of the metal particles having a predetermined valency state after undergoing the oxidation reaction.
10. The method of clause 9, wherein the valency state includes a (II) state or a (III) state.
11. The method of any of clauses 4 to 10, wherein increasing the rate that the metal particles capture the one or more solutes in the mixture includes decreasing the ORP of the mixture.
12. The method of clause 11, wherein decreasing the ORP of the mixture includes adding or increasing a level of a reducing agent in the mixture.
13. The method of clause 12, wherein the reducing agent includes at least one of calcium, an oxygen-consuming microorganism, a nitride, a nitrate, sodium borohydride, an alcohol, or a phenol.
14. The method of any of clauses 11 to 13, wherein decreasing the ORP of the mixture includes decreasing a temperature of the mixture and/or injecting nitrogen gas into the mixture.
15. The method of any of clauses 4 to 14, wherein increasing the rate that the metal particles capture the one or more solutes in the mixture includes increasing the ORP of the mixture by: increasing a temperature of the mixture; and/or adding or increasing a level of an oxidizing agent in the mixture.
16. The method of clause 15, wherein the oxidizing agent includes at least one of air, oxygen gas, hydrogen peroxide, sodium hypochlorite, sodium perchlorate, or potassium permanganate.
17. The method of any of clauses 4 to 16, further including: removing at least a portion of the one or more solutes captured by the metal particles from the mixture by removing the metal particles from the mixture.
18. A desalination system, including: a desalination tank configured to hold a mixture of metal particles and an aqueous solution including water and one or more solutes, the metal particles being configured to capture the one or more solutes by undergoing an oxidation reaction; a sensor configured to detect a condition of the mixture; a redox agent source; and a processor configured to cause, based on the condition of the mixture, the redox agent source to increase a rate that the metal particles capture the one or more solutes by outputting a reduction agent or an oxidation agent into the desalination tank.
19. The desalination system of clause 18, wherein the condition of the mixture includes an ORP of the mixture, wherein the processor is configured to cause, based on the condition of the mixture, the redox agent source to increase the rate that the metal particles capture the one or more solutes by: determining that the ORP of the mixture is above a threshold; and causing the redox agent source to lower the ORP of the mixture by outputting a reduction agent into the mixture.
20. The desalination system of clause 18 or 19, further including: a filter or settling tank configured to separate the one or more solutes captured by the metal particles from the water.

### CONCLUSION

The features disclosed in the foregoing description, or the following claims, or the accompanying drawings, expressed in their specific forms or in terms of a means for performing the disclosed function, or a method or process for attaining the disclosed result, as appropriate, may, separately, or in any combination of such features, be used for realizing implementations of the disclosure in diverse forms thereof.

As will be understood by one of ordinary skill in the art, each implementation disclosed herein can comprise, consist essentially of or consist of its particular stated element, step, or component. Thus, the terms “include” or “including” should be interpreted to recite: “comprise, consist of, or consist essentially of.” The transition term “comprise” or “comprises” means has, but is not limited to, and allows for the inclusion of unspecified elements, steps, ingredients, or components, even in major amounts. The transitional phrase “consisting of” excludes any element, step, ingredient or component not specified. The transition phrase “consisting essentially of” limits the scope of the implementation to the specified elements, steps, ingredients or components and to those that do not materially affect the implementation. As used herein, the term “based on” is equivalent to “based at least partly on,” unless otherwise specified.

Unless otherwise indicated, all numbers expressing quantities, properties, conditions, and so forth used in the specification and claims are to be understood as being modified in all instances by the term “about.” Accordingly, unless indicated to the contrary, the numerical parameters set forth in the specification and attached claims are approximations that may vary depending upon the desired properties sought to be obtained by the present disclosure. At the very least, and not as an attempt to limit the application of the doctrine of equivalents to the scope of the claims, each numerical parameter should at least be construed in light of the number of reported significant digits and by applying ordinary rounding techniques. When further clarity is required, the term “about” has the meaning reasonably ascribed to it by a person skilled in the art when used in conjunction with a stated numerical value or range, i.e. denoting somewhat more or somewhat less than the stated value or range, to within a range of ±20% of the stated value; ±19% of the stated value; ±18% of the stated value; ±17% of the stated value; ±16% of the stated value; ±15% of the stated value; ±14% of the stated value; ±13% of the stated value; ±12% of the stated value; ±11% of the stated value; ±10% of the stated value; ±9% of the stated value; ±8% of the stated value; ±7% of the stated value; ±6% of the stated value; ±5% of the stated value; ±4% of the stated value; ±3% of the stated value; ±2% of the stated value; or ±1% of the stated value.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements.

The terms “a,” “an,” “the” and similar referents used in the context of describing implementations (especially in the context of the following claims) are to be construed to cover both the singular and the plural, unless otherwise indicated herein or clearly contradicted by context. Recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein is intended merely to better illuminate implementations of the disclosure and does not pose a limitation on the scope of the disclosure. No language in the specification should be construed as indicating any non-claimed element essential to the practice of implementations of the disclosure.

Groupings of alternative elements or implementations disclosed herein are not to be construed as limitations. Each group member may be referred to and claimed individually or in any combination with other members of the group or other elements found herein. It is anticipated that one or more members of a group may be included in, or deleted from, a group for reasons of convenience and/or patentability. When any such inclusion or deletion occurs, the specification is deemed to contain the group as modified thus fulfilling the written description of all Markush groups used in the appended claims.

What is claimed is:

1. A system, comprising:
one or more desalination tanks configured to receive an aqueous solution comprising water, sodium ions, and chloride ions;
a desalination media source configured to generate a mixture of the aqueous solution and a desalination media by outputting a desalination media into the one or more desalination tanks, the desalination media comprising metal nanoparticles configured to capture the sodium ions and the chloride ions by undergoing oxidation;
an oxidation-reduction potential (ORP) sensor configured to detect an ORP of the mixture;
a redox agent source; and
a processor configured to:
compare the ORP of the mixture to a threshold; and
based on comparing the ORP of the mixture to the threshold, increasing a rate at which the metal nanoparticles capture the sodium ions and the chloride ions by causing the redox agent source to:
output a redox agent into the one or more desalination tanks; or
increase a level of the redox agent in the mixture.

2. The system of claim 1, wherein the processor is configured to compare the ORP of the mixture to the threshold by determining that the ORP of the mixture is above the threshold, and
wherein the redox agent comprises a reducing agent, the reducing agent comprising at least one of nitrogen gas, an oxygen-consuming microorganism, a nitride, a nitrate, or calcium.

3. The system of claim 1, wherein the processor is configured to compare the ORP of the mixture to the threshold by determining that the ORP of the mixture is below the threshold, and
wherein the redox agent comprises an oxidizing agent, the oxidizing agent comprising at least one of air, oxygen gas, hydrogen peroxide, sodium hypochlorite, sodium perchlorate, or potassium permanganate.

4. A method, comprising:
generating a mixture of metal particles and an aqueous solution comprising one or more solutes, the metal particles being configured to capture the one or more solutes by undergoing an oxidation reaction;
detecting a condition of the mixture;
comparing the condition of the mixture to a threshold;
based on comparing the condition of the mixture to the threshold, increasing a rate that the metal particles capture the one or more solutes in the mixture by increasing or decreasing an ORP of the mixture.

5. The method of claim 4, wherein the metal particles comprise nanoparticles.

6. The method of claim 4, wherein the metal particles comprise at least one zero valency metal.

7. The method of claim 4, wherein the metal particles comprise at least one of iron, zinc, copper, aluminum, magnesium, or manganese.

8. The method of claim 4, wherein the one or more solutes comprise at least one of sodium ions, copper ions, zinc ions, magnesium ions, manganese ions, aluminum ions, arsenic ions, chloride ions, selenium ions, phosphate ions, sulfate ions, nitrate ions, nitrite ions, or hypochlorite ions.

9. The method of claim 4, wherein the condition comprises the ORP of the mixture, a pH of the mixture, or an amount of the metal particles having a predetermined valency state after undergoing the oxidation reaction.

10. The method of claim 9, wherein the valency state comprises a (II) state or a (III) state.

11. The method of claim 4, wherein increasing the rate that the metal particles capture the one or more solutes in the mixture comprises decreasing the ORP of the mixture.

12. The method of claim 11, wherein decreasing the ORP of the mixture comprises adding or increasing a level of a reducing agent in the mixture.

13. The method of claim 12, wherein the reducing agent comprises at least one of calcium, an oxygen-consuming microorganism, a nitride, a nitrate, sodium borohydride, an alcohol, or a phenol.

14. The method of claim 11, wherein decreasing the ORP of the mixture comprises decreasing a temperature of the mixture and/or injecting nitrogen gas into the mixture.

15. The method of claim 4, wherein increasing the rate that the metal particles capture the one or more solutes in the mixture comprises increasing the ORP of the mixture by:
increasing a temperature of the mixture; and/or
adding or increasing a level of an oxidizing agent in the mixture.

16. The method of claim 15, wherein the oxidizing agent comprises at least one of air, oxygen gas, hydrogen peroxide, sodium hypochlorite, sodium perchlorate, or potassium permanganate.

17. The method of claim 4, further comprising:
removing at least a portion of the one or more solutes captured by the metal particles from the mixture by removing the metal particles from the mixture.

18. A desalination system, comprising:
a desalination tank configured to hold a mixture of metal particles and an aqueous solution comprising water and one or more solutes, the metal particles being configured to capture the one or more solutes by undergoing an oxidation reaction;
a sensor configured to detect a condition of the mixture;
a redox agent source; and
a processor configured to cause, based on the condition of the mixture, the redox agent source to increase a rate that the metal particles capture the one or more solutes by outputting a reduction agent or an oxidation agent into the desalination tank.

19. The desalination system of claim 18, wherein the condition of the mixture comprises an ORP of the mixture,
wherein the processor is configured to cause, based on the condition of the mixture, the redox agent source to increase the rate that the metal particles capture the one or more solutes by:
determine that the ORP of the mixture is above a threshold; and
cause the redox agent source to lower the ORP of the mixture by outputting a reduction agent into the mixture.

20. The desalination system of claim 18, further comprising:
a filter or settling tank configured to separate the one or more solutes captured by the metal particles from the water.
